(19) United States
(12) Patent Application Publication
(10) Pub. No.: US 2005/0192384 A1
(43) Pub. Date: Sep. 1, 2005

(54) Additive composition for increasing the storage stability of ethylenically unsaturated resins

(76) Inventors: Tunja Jung, Rheinfelden-Herten (DE); Andreas Valet, Binzen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/040,727

(22) Filed: Jan. 21, 2005

Related U.S. Application Data
(63) Continuation-in-part of application No. 10/148,864, filed on Jun. 5, 2002.

(30) Foreign Application Priority Data
Dec. 9, 1999 (CH) 2270/99

(51) Int. Cl. C08K 5/34

(52) U.S. Cl. 524/99

(57) ABSTRACT

The invention relates to a composition comprising a1) at least one oligomer, co-oligomer, polymer or copolymer or a mixture thereof having at least one ethylenically unsaturated bond; or a2) a mixture of at least one ethylenically unsaturated monomer with at least one oligomer, co-oligomer, polymer or copolymer having at least one ethylenically unsaturated bond; and b) at least one stable sterically hindered nitroxyl free-radical or at least one compound of the benzofuran-2-one type or a mixture of the two compounds. The invention relates also to a method of stabilising ethylenically unsaturated monomers, oligomers, co-oligomers, polymers or copolymers, and to the use of a stable sterically hindered nitroxyl free-radical or a compound of the benzofuran-2-one type in preventing polymerisation or crosslinking.

The present invention relates to the stabilisation of ethylenically unsaturated resins against premature polymerisation or crosslinking during transportation and storage.

Unsaturated resins, especially those to be cured by radiation, frequently have to be stabilised against undesired polymerisation or crosslinking in order that they have adequate storage stability.

In the prior art, for example in U.S. Pat. No. 5,863,997 or EP-A0 306 444, there are proposed for that purpose especially phenolic compounds, more especially those based on quinone/hydroquinone or phenothiazine.

Examples of typical additives intended to prevent premature polymerisation are hydroquinone, hydroquinone derivatives, p-methoxyphenol, β-naphthol and sterically hindered phenols, e.g. 2,6-di(tert-butyl)-p-cresol.

A disadvantage of such additives is that after exposure to UV light, which is used, for example, for the radiation-curing of surface-coatings, a visible yellowing occurs. UV exposure may also occur during use, for example in the case of surface-coatings that are exposed to actinic radiation when used outdoors. In that case too the hydroquinone/quinone stabilisers used can lead to undesirable yellowing.

The problem underlying the present invention is therefore to provide stabilisers for increasing the storage stability of unsaturated polymers, oligomers and monomers that bring about adequate or even improved storage stability and give rise to no, or only slight, yellowing under the action of UV light.

It has now been found, surprisingly, that this problem is solved by adding to the polymers, oligomers or monomers compounds from the class of the benzofuran-2-ones and/or from the class of the stable sterically hindered nitroxyl free-radicals.

The compounds are known per se and are described for various applications in the prior art.

Examples of benzofuran-2-ones can be found in U.S. Pat. No. 5,814,692 or in U.S. Pat. No. 5,773,631.

Stable sterically hindered nitroxyl free-radicals are described, for example, in EP-A-581 737.

The invention relates to a composition comprising
a1) at least one oligomer, co-oligomer, polymer or copolymer or a mixture thereof having at least one ethylenically unsaturated bond; or
a2) a mixture of at least one ethylenically unsaturated monomer with at least one oligomer, co-oligomer, polymer or copolymer having at least one ethylenically unsaturated bond; and
b) at least one stable sterically hindered nitroxyl free-radical or at least one compound of the benzofuran-2-one type or a mixture of the two compounds.

In the context of the present invention at least one ethylenically unsaturated monomer, oligomer, co-oligomer, polymer or copolymer means in each case that two, three or more of the corresponding unsaturated compounds may be present. Depending upon the field of use, in order to achieve the properties required for the application in question a complex mixture of different monomers, oligomers, co-oligomers, polymers or copolymers may be necessary.

In the case of a1), therefore, chemically different ethylenically unsaturated oligomers, co-oligomers, polymers or copolymers may be present, their ratio to one another being governed by the requirements of the field of use in question. Where there are three components, the amount of each component may be, for example, from 5 to 50 parts, the parts adding up to a total of 100.

In the case of a2), the proportion of monomers may be from 0.1 to 50 parts, preferably from 1 to 30 parts, and the oligomers, co-oligomers, polymers or copolymers together with the monomers add up to a total of 100 parts.

Preference is given to a composition in which the monomer, oligomer, co-oligomer, polymer or copolymer has at least 2 ethylenically unsaturated bonds.

The composition is preferably liquid, but where one or more components are solid solvents may also be present. Preferably as little solvent as possible is added. Where necessary, therefore, from 5 to 20% by weight, based on the total composition, is typical.

Preferably the monomers, oligomers, co-oligomers, polymers or copolymers are themselves liquid or resinous at room temperature.

In the case of solid components, these can be dissolved, for example, in a liquid component (monomer) but it is also possible to dissolve the component in a solvent beforehand and add it to the mixture in the form of a solution. Suitable solvents are, for example, ethers, esters, aliphatic or aromatic hydrocarbons, amides or alcohols.

Preference is also given to a composition wherein the monomer, oligomer, co-oligomer, polymer or copolymer contains at least one acrylate or methacrylate functionality or is a polyester derived from an unsaturated acid.

Preferably the unsaturated compounds of component (a1, a2) are photopolymerisable or radiation-curable compounds.

The ethylenically unsaturated compounds (a1, a2) may contain one or more olefinic double bonds. They may be low molecular weight (monomeric) or higher molecular weight (oligomeric). Examples of monomers having a double bond are alkyl and hydroxyalkyl acrylates and methacrylates, e.g. methyl, ethyl, butyl, 2-ethylhexyl and 2-hydroxyethyl acrylate, isobornyl acrylate and methyl and ethyl methacrylate. Also of interest are silicone acrylates. Further examples are acrylonitrile, acrylamide, methacrylamide, N-substituted (meth)acrylamides, vinyl esters, such as vinyl acetate, vinyl ethers, such as isobutyl vinyl ether, styrene, alkyl- and halo-styrenes, N-vinylpyrrolidone, vinyl chloride and vinylidene chloride.

Examples of monomers having several double bonds are ethylene glycol diacrylate, propylene glycol diacrylate, neopentyl glycol diacrylate, hexamethylene glycol diacrylate, bisphenol-A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinyl-benzene, divinyl succinate, diallyl phthalate, triallyl phosphate, triallyl isocyanurate and tris(2-acryloylethyl)isocyanurate.

Examples of higher molecular weight (oligomeric, polymeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. Combinations of vinyl-ether-group-carrying oligomers and polymers, as described in WO 90/01512, are especially suitable, but copolymers of vinyl ether and monomers functionalised with maleic acid also come into consideration. Such unsaturated oligomers can also be termed prepolymers.

Especially suitable are, for example, esters of ethylenically unsaturated carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, itaconic acid, cinnamic acid and unsaturated fatty acids such as linolenic acid or oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or fully esterified by one or by different unsaturated carboxylic acid(s), it being possible for the free hydroxyl groups in partial esters to have been modified, for example etherified, or esterified by other carboxylic acids.

Examples of esters are:
trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,4-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as component (a1, a2) are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diamino-cyclohexane, isophoronediamine, phenylenediamine, bisphenylenediamine, di-β-aminoethyl ether, diethylenetriamine, triethylenetetramine and di(β-aminoethoxy)- and di(β-aminopropoxy)ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N[(β-hydroxyethoxy)ethyl]-acrylamide.

Suitable unsaturated polyesters and polyamides are derived, for example, from maleic acid and diols or diamines. The maleic add may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene, hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

The compounds of component (a1, a2) can be used on their own or in any desired mixtures. Preferably mixtures of polyol (meth)acrylates are used.

Preferred monomer, oligomer and polymer components for such mixtures are described by way of example above.

Suitable mono-, di-, tri- and higher-functional components are commercially available.

The molecular weights of the oligomers, co-oligomers, polymers or copolymers may range from approximately 100 to 100 000, preferably from 200 to 10 000 and especially from 500 to 5000.

Preference is given to photopolymerisable mixtures that comprise one or more photoinitiators as further component. Examples of photoinitiators are given below.

As photoinitiators it is possible in principle to add any initiators known from the prior art.

Typical examples are mentioned below, which can be used both on their own or in admixture with one another. For example, benzophenones, benzophenone derivatives, acetophenone, acetophenone derivatives, e.g. α-hydroxycycloalkylphenylketones or 2-hydroxy-2-methyl-1-phenylpropanone, dialkoxyacetophenones, α-hydroxy- or α-amino-acetophenones, e.g. (4-methylthiobenzoyl)-1-methyl-1-morpholino-ethane, (4-morpholino-benzoyl)-1-benzyl-1-dimethylaminopropane, 4-aroyl-1,3-dioxolanes, benzoin alkyl ethers and benzil ketals, e.g. benzil dimethyl ketal, phenyl glyoxalates and derivatives thereof, dimeric phenylglyoxalates, monoacylphosphine oxides, e.g. (2,4,6-trimethylbenzoyl)phenylphosphine oxide, bisacylphosphine oxides, e.g. bis(2,6-dimethoxybenzoyl)-(2,4,4-trimethyl-pent-1-yl)phosphine oxide, bis(2,4,6-trimethylbenzoyl)phenylphosphine oxide or bis(2,4,6-trimethylbenzoyl)-(2,4-dipentyloxyphenyl)phosphine oxide, trisacylphosphine oxides, ferrocenium compounds or titanocenes, e.g. dicyclopentadienyl-bis(2,6-difluoro-3-pyrrolo-phenyl)titanium. A further class of suitable photoinitiators is that of the oxime esters. The following compounds may be mentioned by way of example: 1-(4-phenylsulfanyl-phenyl)-butane-1,2-dione 2-oxime-O-benzoate, 1-(4-phenylsulfanyl-phenyl)-octane-1,2-dione 2-oxime-O-benzoate, 1-(4-phenylsulfanyl-phenyl)-octan-1-one oxime-O-acetate, 1-(4-phenylsulfanyl-phenyl)-butan-1-one oxime-O-acetate and 1-(4-phenylsulfanyl-phenyl)-octane-1,2-dione 2-oxime-O-benzoate.

As co-initiators there come into consideration, for example, sensitisers that shift or broaden the spectral sensitivity and thus bring about an acceleration of the photopolymerisation. They are especially aromatic carbonyl compounds such as e.g. benzophenone, thioxanthone, especially isopropylthioxanthone, anthraquinone and 3-acylcoumarin derivatives, terphenyls, styryl ketones, and also 3-(aroylmethylene)-thiazolines, camphor quinone, but also eosine, rhodamine and erythrosin dyes.

Further examples of photosensitisers are

1. Thioxanthones

Thioxanthone, 2-isopropylthioxanthone, 2-chlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholino-ethyl)-thioxanthone, 2-methyl-6-dimethoxymethyl-thioxanthone, 2-methyl-6-(1,1-dimethoxybenzyl)-thioxanthone, 2-morpholinomethylthioxanthone, 2-methylmorpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride;

2. Benzotohenones

Benzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl-2-benzoylbenzoate, 4-(2-hydroxyethylthio)-benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethyl-benzenemethanaminium chloride;

3. 3-Acylcoumarins

3-Benzoylcoumarin, 3-benzoyl-7-methoxycoumarin, 3-benzoyl-5,7-di(propoxy)coumarin, 3-benzoyl-6,8-dichlorocoumarin, 3-benzoyl-6-chlorocoumarin, 3,3′-carbonyl-bis[5,7-di(propoxy)coumarin], 3,3′-carbonyl-bis(7-methoxycoumarin), 3,3′-carbonyl-bis(7-diethylaminocoumarin), 3-isobutyroylcoumarin, 3-benzoyl-5,7-dimethoxycoumarin, 3-benzoyl-5,7-diethoxycoumarin, 3-benzoyl-5,7-dibutoxycoumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-dimethoxy-3-(1-naphthoyl)-coumarin, 3-benzoylbenzo[f]-coumarin, 7-diethylamino-3-thienoylcoumarin, 3-(4-cyanobenzoyl)-5,7-dimethoxycoumarin;

4. 3-(Aroylmethylene)-thiazolines

3-Methyl-2-benzoylmethylene-β-naphthothiazoline, 3-methyl-2-benzoylmethylene-benzothiazoline, 3-ethyl-2-propionylmethylene-β-naphthothiazoline;

5. Other Carbonyl Compounds

Acetophenone, 3-methoxyacetophenone, 4-phenylacetophenone, benzil, 2-acetyl-naphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethylamino-benzylidene)ketones, such as 2-(4-dimethylamino-benzylidene)-indan-1-one or 3-(4-dimethylamino-phenyl)-1-indan-5-yl-propenone, 3-phenylthiophthalimide, N-methyl-3,5-di(ethylthio)phthalimide, N-methyl-3,5-di(ethylthio)phthalimide.

It is also possible to add non-reactive binders to the compositions according to the invention. The amount of binder may be, for example, from 5 to 40% by weight, based on the total solids. The choice of binder is made according to the field of use and the properties required therefor, such as developability in aqueous and organic solvent systems, adhesion to substrates and oxygen sensitivity.

Suitable binders are, for example, polymers having a molecular weight of approximately from 5000 to 2 000 000, preferably from 10 000 to 1 000 000. Examples are: homo- and copolymers of acrylates and methacrylates, e.g. copolymers of methyl methacrylate/ethyl acrylate/methacrylic acid, poly(methacrylic acid alkyl esters), poly(acrylic acid alkyl esters); cellulose esters and ethers, such as cellulose acetate, cellulose acetate butyrate, methylcellulose, ethylcellulose; polyvinylbutyral, polyvinylformal, cyclised caoutchouc, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, copoly(ethylene/vinyl acetate), polymers such as polycaprolactam and poly(hexamethylene adipamide), polyesters such as poly(ethylene glycol terephthalate) and poly(hexamethylene glycol succinate).

The unsaturated compounds can also be used in admixture with non-photopolymerisable film-forming components. These may be, for example, polymers that can be dried physically or solutions thereof in organic solvents, for example nitrocellulose or cellulose acetobutyrate, but they may also be chemically or thermally curable resins, for example polyisocyanates, polyepoxides or melamine resins. The concomitant use of thermally curable resins is important for use in so-called hybrid systems, which are photopolymerised in a first step and crosslinked by thermal after-treatment in a second step.

The thermocurable component is, for example, generally a film-forming binder based on a thermoplastic or thermocurable resin, predominantly on a thermocurable resin. Examples thereof are alkyd, acrylic, polyester, phenolic, melamine, epoxy and polyurethane resins and mixtures thereof. Examples thereof are described, for example, in Ullmann's Encyclopedia of Industrial Chemistry, 5th Ed., Vol. A18, pp. 368-426, VCH, Weinheim 1991.

It may be a cold-curable or hot-curable binder, with the addition of a curing catalyst possibly being advantageous. Suitable catalysts that accelerate the full cure of the binder are described, for example, in Ullmann's Encyclopedia of Industrial Chemistry, Vol. A18, page 469, VCH Verlagsgesellschaft, Weinheim 1991.

Examples of suitable specific binders are:
1. surface-coatings based on cold- or hot-crosslinkable alkyd, acrylate, polyester, epoxy or melamine resins or mixtures of such resins, optionally with the addition of a curing catalyst;
2. two-component polyurethane surface-coatings based on hydroxyl-group-containing acrylate, polyester or polyether resins and aliphatic or aromatic isocyanates, isocyanurates or polyisocyanates;
3. one-component polyurethane surface-coatings based on blocked isocyanates, isocyanurates or polyisocyanates, which are de-blocked during stoving; it is also possible to add melamine resins as appropriate;
4. one-component polyurethane surface-coatings based on aliphatic or aromatic urethanes or polyurethanes and hydroxy-group-containing acrylate, polyester or polyether resins;
5. one-component polyurethane surface-coatings based on aliphatic or aromatic urethane acrylates or polyurethane acrylates having free amine groups in the urethane structure and melamine resins or polyether resins, optionally with the addition of a curing catalyst;
6. two-component surface-coatings based on (poly)ketimines and aliphatic or aromatic isocyanates, isocyanurates or polyisocyanates;
7. two-component surface-coatings based on (poly)ketimines and an unsaturated acrylate resin or a polyacetoacetate resin or a methacrylamidoglycolate methyl ester;
8. two-component surface-coatings based on carboxy- or amino-group-containing polyacrylates and polyepoxides;
9. two-component surface-coatings based on anhydride-group-containing acrylate resins and a polyhydroxy or polyamino component;
10. two-component surface-coatings based on acrylate-containing anhydrides and polyepoxides;
11. two-component surface-coatings based on (poly)oxazolines and anhydride-group-containing acrylate resins or unsaturated acrylate resins or aliphatic or aromatic isocyanates, isocyanurates or polyisocyanates;
12. two-component surface-coatings based on unsaturated polyacrylates and polymalonates;
13. thermoplastic polyacrylate surface-coatings based on thermoplastic acrylate resins or extrinsically crosslinking acrylate resins in combination with etherified melamine resins;
14. surface-coating systems based on urethane (meth)acrylate having (meth)acryloyl groups and free isocyanate groups and on one or more compounds that react with isocyanates, for example free or esterified polyols. Such systems have been published, for example, in EP 928 800.

Blocked isocyanates, as may also be used therein, are described, for example, in Organischer Metallschutz: Entwicklung und Anwendung von Beschichtungsstoffen, pages 159-160, Vincentz Verlag, Hannover (1993). These are compounds in which the highly reactive NCO group is “blocked” by reaction with specific radicals, for example primary alcohols, phenol, acetoacetic ester, ε-caprolactam, phthalimide, imidazole, oxime or amine. The blocked isocyanate is stable in liquid systems and also in the presence of hydroxy groups. On heating, the blocking agents are removed again and the NCO group is freed.

Both 1-Component (1C) and 2-component (2C) systems may be used. Examples of such systems are described in Ullmann's Encyclopedia of Industrial Chemistry, Vol. A18, Paints and Coatings, pages 404-407, VCH Verlagsgesellschaft mbH, Weinheim (1991).

It is possible to optimise the composition by specially adapting the formulation, for example by varying the binder/crosslinking agent ratio. Such measures will be known to the person skilled in the art of surface-coating technology.

Preferred as thermocurable component is a mixture based on acrylate/melamine (and melamine derivatives), 2-component polyurethane, 1-component polyurethane, 2-component epoxy/carboxy or 1-component epoxy/carboxy. Mixtures of those systems are also possible, for example the addition of melamine (or derivatives thereof) to 1-component polyurethanes.

Special preference is given to a binder based on a polyacrylate with melamine or a melamine derivative. Also preferred is a system based on a polyacrylate or/and polyester polyol with a non-blocked polyisocyanate or polyisocyanurate.

Also included are compositions comprising as component (a1, a2) at least one ethylenically unsaturated photopolymerisable compound dissolved or emulsified in water. Such aqueous radiation-curable prepolymer dispersions are commercially available in many variations and are described in the literature. They are to be understood as being dispersions consisting of water and at least one prepolymer dispersed therein. The concentration of water in such systems is, for example, from 5 to 80% by weight, especially from 30 to 60% by weight. The radiation-curable prepolymer or mixture of prepolymers is present, for example, in concentrations of from 95 to 20% by weight, especially from 70 to 40% by weight. In such compositions the sum of the percentages mentioned for water and prepolymer will be 100 in each case, the auxiliaries and additives, which will be present in varying amounts in accordance with the intended use, being in addition thereto.

The radiation-curable film-forming prepolymers, which are dispersed or in many cases dissolved in water, are mono- or poly-functional ethylenically unsaturated prepolymers that can be initiated by free radicals, for example such as those described above, which prepolymers are known per se for aqueous prepolymer dispersions and contain, for example, from 0.01 to 1.0 mol of polymerisable double bonds per 100 g of prepolymer and have an average molecular weight of, for example, at least 400, especially of from 500 to 10 000. Prepolymers having higher molecular weights may also be suitable, however, depending upon the intended use. There are used, for example, polymerisable C—C double-bond-containing polyesters having an acid number of a maximum of 10, polymerisable C—C double-bond-containing polyethers, hydroxyl-group-containing reaction products of a polyepoxide containing at least two epoxy groups per molecule with at least one α,β-ethylenically unsaturated carboxylic acid, polyurethane(meth)acrylates and acrylic copolymers containing cap-ethylenically-unsaturated acrylic radicals, as described in EP 12 339. Mixtures of those prepolymers may also be used. Also suitable are the polymerisable prepolymers described in EP 33 896, which are thioether adducts of polymerisable prepolymers having an average molecular weight of at least 600, a carboxyl group content of from 0.2 to 15% and a content of from 0.01 to 0.8 mol of polymerisable C—C double bonds per 100 g of prepolymer. Other suitable aqueous dispersions based on specific (meth)acrylic acid alkyl ester polymerisation products are described in EP 41 125, and suitable water-dispersible radiation-curable prepolymers of urethane acrylates can be found in DE 2 936 039. Further descriptions of aqueous radiation-curable formulations have been published, for example, by H. Lange in Farbe+Lack, Vol. 99, 7/93, pages 597-601 and W. Reich, K. Menzel and W. Schrof in Farbe+Lack, Vol. 104, 12/98, pages 73-80.

As further additives the radiation-curable aqueous prepolymer dispersions may comprise dispersing agents, emulsifiers, anti-oxidants, light stabilisers, dyes, pigments, fillers, e.g. talc, gypsum, silicic acid, rutile, carbon black, zinc oxide, iron oxides, reaction accelerators, flow agents, glidants, wetting agents, thickeners, matting agents, antifoams and other adjuvants customary in surface-coating technology. Suitable dispersing agents include water-soluble high molecular weight organic compounds having polar groups, e.g. polyvinyl alcohols, polyvinylpyrrolidone and cellulose ethers. As emulsifiers it is possible to use non-ionic and, where appropriate, ionic emulsifiers.

The photopolymerisable monomers, oligomers, co-oligomers, polymers or copolymers containing at least one ethylenically unsaturated bond can, when formulated as mixtures, be formulated for very specific uses. Examples are clear lacquers, printing inks, pigmented surface-coatings, etch resists or solder resists in the semiconductor industry.

Further additives may also be present according to the intended use.

For example, in addition to the stabilisers (b) according to the invention, further stabilisers, e.g. hydroquinone, p-methoxyphenol, β-naphthol or sterically hindered phenols, such as 2,6-di(tert-butyl)-p-cresol, may be present.

The formulations may also contain as additional additives dyes and/or white or coloured pigments. Depending upon the intended use, both inorganic and organic pigments may be used. Such additives will be known to the person skilled in the art; some examples are titanium dioxide pigments, e.g. of the rutile or anatase type, carbon black, zinc oxide, such as zinc white, iron oxides, such as iron oxide yellow, iron oxide red, chromium yellow, chromium green, nickel titanium yellow, ultramarine blue, cobalt blue, bismuth vanadate, cadmium yellow and cadmium red. Examples of organic pigments are mono- or bis-azo pigments, and also metal complexes thereof, phthalocyanine pigments, polycyclic pigments, e.g. perylene, anthraquinone, thioindigo, quinacridone or triphenylmethane pigments, and also diketo-pyrrolo-pyrrole, isoindolinone, e.g. tetrachloroisoindolinone, isoindoline, dioxazine, benzimidazolone and quinophthalone pigments.

The pigments may be used in the formulations on their own or in admixture. Depending upon the intended use, the pigments are added to the formulations in amounts customary in the art, for example in an amount of from 0.1 to 60% by weight, e.g. from 1 to 60% by weight, for example 10 to 50 or 10 to 40% by weight, based on the total mass.

The formulations may also comprise, for example, organic dyes of an extremely wide variety of classes. Examples are azo dyes, methine dyes, anthraquinone dyes and metal complex dyes. Customary concentrations are, for example, from 0.1 to 20%, especially from 1 to 5%, based on the total mass.

In addition to the additives mentioned above, the composition may also comprise further additives, especially light stabilisers.

Examples thereof are listed below.

UV Absorbers and Light Stabilisers

1. 2-(2′-Hydroxyphenyl)-benzotriazoles, e.g. 2-(2′-hydroxy-5′-methylphenyl)-benzotriazole, 2-(3′,5′-di-tert-butyl-2′-hydroxyphenyl)-benzotriazole, 2-(5′-tert-butyl-2′-hydroxyphenyl)-benzotriazole, 2-(2′-hydroxy-5′-(1,1,3,3-tetramethylbutyl)-phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)-benzotriazole, 2-(2′-hydroxy-4′-octyloxyphenyl)-benzotriazole, 2-(3′,5′-di-tert-amyl-2′-hydroxyphenyl)-benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenyl)-benzotriazole, 2-(3′-dodecyl-2′-hydroxy-5′-methylphenyl)-benzotriazole, 2-(3′-tert-butyl-2′-hydroxy-5′-(2-isooctyloxycarbonylethyl)-phenyl-benzdriazole, 2,2′-methylene-bis[4-(1,1,3,3-tetramethylbutyl)-6-benzotriazol-2-yl-phenol]; the transesterification product of 2-[3′-tert-butyl-5′-(2-methoxycarbonylethyl)-2′-hydroxyphenyl]-benzotriazole with polyethylene glycol 300; [R—CH₂CH₂—COO—CH₂CH₂ [symbol] ₂ wherein R=3′-tert-butyl-4′-hydroxy-5′-2H-benzotriazol-2-yl-phenyl; 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]-benzotriazole.

2. Hydroxybenzophenones, e.g the 4-hydroxy, 4-methoxy, 4-octyloxy, 4-decyloxy, 4-dodecyloxy, 4-benzyloxy, 4,2′,4′-trihydroxy or 2′-hydroxy-4,4′-dimethoxy derivative.

3. Esters of unsubstituted or substituted benzoic acids, e.g. 4-tert-butyl-phenyl salicylate, phenyl salicylate, octylphenyl salicylate, dibenzoylresorcinol, bis(4-tert-butylbenzoyl)-resorcinol, benzoylresorcinol, 3,5-di-tert-butyl-4-hydroxybenzoic acid 2,4-di-tert-butylphenyl ester, 3,5-di-tert-butyl-4-hydroxybenzoic acid hexadecyl ester, 3,5-di-tert-butyl-4-hydroxybenzoic acid octadecyl ester and 3,5-di-tert-butyl-4-hydroxybenzoic acid 2-methyl-4,6-di-tert-butylphenyl ester.

4. Acrylates, e.g. α-cyano-β,β-diphenylacrylic acid ethyl ester or isooctyl ester, α-methoxycarbonylcinnamic acid methyl ester, α-cyano-β-methyl-p-methoxycinnamic acid methyl ester or butyl ester, α-methoxycarbonyl-p-methoxycinnamic acid methyl ester and N-(β-methoxycarbonyl-β-cyanovinyl)-2-methyl-indoline.

5. Sterically hindered amines, for example bis(2,2,6,6-tetramethylpiperidin-4-yl)sebacate, bis(2,2,6,6-tetramethylpiperidin-4-yl)succinate, bis(1,2,2,6,6-pentamethylpiperidin-4-yl) sebacate, bis(1-octoxy-2,2,6,6-tetramethylpiperidin-4-yl)sebacate, n-butyl-3,5-di-tert-butyl-4-hydroxybenzylmalonic acid bis(1,2,2,6,6-pentamethylpiperidyl)ester, condensation product of 1-hydroxyethyl-2,2,6,6-tetramethyl-4-hydroxypiperidine and succinic acid, linear or cyclic condensation products of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl) 1,2,3,4-butanetetraoate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro-[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensation products of N,N′-bis(2,2,6,6-tetramethylpiperidyl)hexamethylenediamine and 4-morpholino-2,6-dichloro-1,3,5-triazine, condensation product of 2-chloro-4,6-di(4-n-butylamino-2,2,6,6-tetramethylpiperidyl)-1,3,5-triazine and 1,2-bis(3-aminopropylamino)ethane, condensation product of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro-[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylenediamine and 4-cyclohexylamino-2,6-dichloro-1,3,5-triazine, condensation product of 1,2-bis(3-aminopropylamino)ethane and 2,4,6-trichloro-1,3,5-triazine and 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4.5]decane, reaction product of 7,7,9,9-tetramethyl-2-cycloundecyl-1-oxa-3,8-diaza4-oxospiro[4.5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic anhydride α-olefin copolymer and 2,2,6,6-tetramethyl-4-aminopiperidine or 1,2,2,6,6-pentamethyl-4-aminopiperidine.

6. Oxalic acid diamides, for example 4,4′-dioctyloxy oxanilide, 2,2′-diethoxy oxanilide, 2,2′-dioctyloxy-5,5′-di-tert-butyl oxanilide, 2,2′-didodecyloxy-5,5′-di-tert-butyl oxanilide, 2-ethoxy-2′-ethyl oxanilide, N,N′-bis(3-dimethylaminopropyl)oxalamide, 2-ethoxy-5-tert-butyl-2′-ethyl oxanilide and a mixture thereof with 2-ethoxy-2′-ethyl-5,4′-di-tert-butyl oxanilide, mixtures of o- and p-methoxy- and also of o- and p-ethoxy-di-substituted oxanilides.

7. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxyoctyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)-phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Such light stabilisers are preferably added in an amount of from 0.01 to 5% by weight, based on component (a).

The stable sterically hindered nitroxyl free-radicals (b) have the following structural feature, 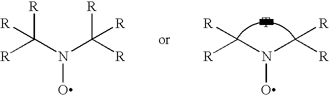
wherein R is alkyl and T is a group required to complete a 5 or 6-membered ring.

R is preferably C₁-C₄alkyl, especially methyl, when it is a cyclic nitroxyl free-radical.

Two or more nitroxyl groups in the same molecule can be linked to one another by way of the group T, as shown below. E has the meaning of a spacer group such as for example a C₁-C₁₂alkylene group.

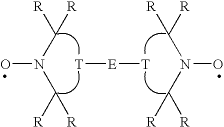

Typical nitroxyl free-radicals are, for example:
bis(1-oxy-2,2,6,6-tetramethylpiperidin-4-yl)sebacate, 4-hydroxy-1-oxy-2,2,6,6-tetramethylpiperidine, 4-ethoxy-1-oxy-2,2,6,6-tetramethylpiperidine, 4-propoxy-1-oxy-2,2,6,6-tetramethylpiperidine, 4-acetamido-1-oxy-2,2,6,6-tetramethylpiperidine, 1-oxy-2,2,6,6-tetramethylpiperidine, 1-oxy-2,2,6,6-tetramethylpiperidin-4-one, 1-oxy-2,2,6,6-tetramethylpiperidin-4-yl acetate, 1-oxy-2,2,6,6-tetramethylpiperidin-4-yl 2-ethylhexanoate, 1-oxy-2,2,6,6-tetramethylpiperidin-4-yl stearate, 1-oxy-2,2,6,6-tetramethylpiperidin-4-yl benzoate, 1-oxy-2,2,6,6-tetramethylpiperidin-4-yl 4-tert-butyl-benzoate, bis(1-oxy-2,2,6,6-tetramethylpiperidin-4-yl) succinate, bis(1-oxy-2,2,6,6-tetramethylpiperidin-4-yl) adipate, bis(1-oxy-2,2,6,6-tetramethylpiperidin-4-yl) n-butylmalonate, bis(1-oxy-2,2,6,6-tetramethylpiperidin-4-yl)phthalate, bis(1-oxy-2,2,6,6-tetramethylpiperidin-4-yl)isophthalate, bis(1-oxy-2,2,6,6-tetramethylpiperidin-4-yl)terephthalate, bis(1-oxy-2,2,6,6-tetramethylpiperidin-4-yl) hexahydroterephthalate, N,N′-bis(1-oxy-2,2,6,6-tetramethylpiperidin-4-yl)adipamide, N-(1-oxy-2,2,6,6-tetramethylpiperidin-4-yl)caprolactam, N-(1-oxy-2,2,6,6-tetramethylpiperidin-4-yl)-dodecylsuccinimide, 2,4,6-tris[N-butyl-N-(1-oxy-2,2,6,6-tetramethylpiperidin-4-yl)]-s-triazine, 4,4′-ethylenebis(1-oxy-2,2,6,6-tetramethylpiperazin-3-one), 2-oxy-1,1,3,3-tetramethyl-2-isobenzazole, 1-oxy-2,2,5,5-tetramethylpyrrolidine and N,N-bis(1,1,3,3-tetramethylbutyl)-nitroxide.

Preferred nitroxyl free-radicals are: bis(1-oxy-2,2,6,6-tetramethylpiperidin-4-yl) sebacate, 4-hydroxy-1-oxy-2,2,6,6-tetramethylpiperidine, 4-ethoxy-1-oxy-2,2,6,6-tetramethylpiperidine, 4-propoxy-1-oxy-2,2,6,6-tetramethylpiperidine, 4-acetamido-1-oxy-2,2,6,6-tetramethylpiperidine, 1-oxy-2,2,6,6-tetramethylpiperidine and 1-oxy-2,2,6,6-tetramethylpiperidin-4-one.

Bis(1-oxy-2,2,6,6-tetramethylpiperidin-4-yl)sebacate and 4-hydroxy-1-oxy-2,2,6,6-tetramethylpiperidine are especially preferred.

The benzofuran-2-ones of component (b) are preferably compounds of formula (I) 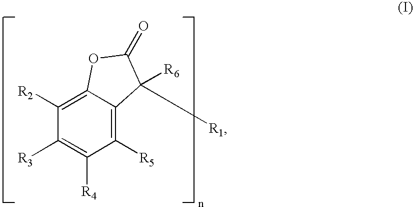
wherein, when n is 1,
R₁ is naphthyl, phenanthryl, anthryl, 5,6,7,8-tetrahydro-2-naphthyl, 5,6,7,8tetrahydro-1-naphthyl, thienyl, benzo[b]thienyl, naphtho[2,3b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, each unsubstituted or substituted by C₁-C₄alkyl, C₁-C₄alkoxy, C₁-C₄alkylthio, hydroxy, halogen, amino, C₁-C₄alkylamino, phenylamino or by di(C₁-C₄alkyl)amino, or R₁ is a radical of formula II 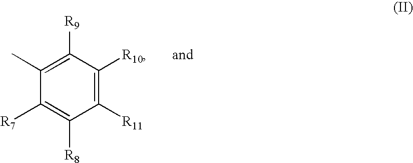
   when n is 2,
R₁ is phenylene or naphthylene, each unsubstituted or substituted by C₁-C₄alkyl or by hydroxy; or is —R₁₂—X—R₁₃—,
R₂, R₃, R₄ and R₅ are each independently of the others hydrogen, chlorine, hydroxy, C₁-C₂₅alkyl, C₇-C₉phenylalkyl, unsubstituted or C₁-C₄alkyl-substituted phenyl; unsubstituted or C₁-C₄alkyl-substituted C₅-C₈cycloalkyl; C₁-C₁₈alkoxy, C₁-C₁₈alkylthio, C₁-C₄alkylamino, di(C₁-C₄alkyl)amino, C₁-C₂₅alkanoyloxy, C₁-C₂₅alkanoylamino, C₃-C₂₅alkenoyloxy, C₃-C₂₅alkanoyloxy interrupted by oxygen, sulfur or by 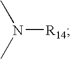
   C₆-C₉cycloalkylcarbonyloxy, benzoyloxy or C₁-C₁₂alkyl-substituted benzoyloxy; or the radicals R₂ and R₃ or the radicals R₃ and R₄ or the radicals R₄ and R₅ together with the carbon atoms to which they are bonded form a benzo ring, or R₄ may additionally be —(CH₂)ₚ—COR₁₅ or —(CH₂)_{q}OH, or when R₃, R₅ and R₆ are hydrogen, R₄ may additionally be a radical of formula III 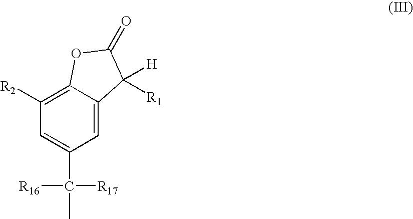
   wherein R₁ is as defined above for n=1,
R₆ is hydrogen or a radical of formula IV 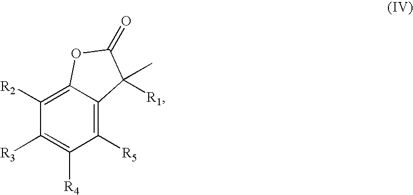
   wherein R₄ is not a radical of formula III and R₁ is as defined above for n=1,
R₇, R₈, R₉, R₁₀ and R₁₁ are each independently of the others hydrogen, halogen, hydroxy, C₁-C₂₅alkyl, C₂-C₂₅alkyl interrupted by oxygen, sulfur or by 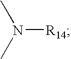
   C₁-C₂₅alkoxy, C₂-C₂₅alkoxy interrupted by oxygen, sulfur or by 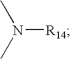
   C₁-C₂₅alkylthio, C₃-C₂₅alkenyl, C₃-C₂₅alkenyloxy, C₃-C₂₅alkynyl, C₃-C₂₅alkynyloxy, C₇-C₉phenylalkyl, C₇-C₉phenylalkoxy, unsubstituted or C₁-C₄alkyl-substituted phenyl; unsubstituted or C₁-C₄alkyl-substituted phenoxy; unsubstituted or C₁-C₄alkyl-substituted C₅-C₈cycloalkyl; unsubstituted or C₁-C₄alkyl-substituted C₅-C₈cycloalkoxy; C₁-C₄alkylamino, di(C₁-C₄alkyl)amino, C₁-C₂₅alkanoyl, C₃-C₂₅alkanoyl interrupted by oxygen, sulfur or by 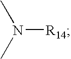
   C₁-C₂₅alkanoyloxy, C₃-C₂₅alkanoyloxy interrupted by oxygen, sulfur or by 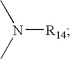
   C₁-C₂₅alkanoylamino, C₃-C₂₅alkenoyl, C₃-C₂₅alkenoyl interrupted by oxygen, sulfur or by 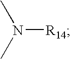
   C₃-C₂₅alkenoyloxy, C₃-C₂₅alkenoyloxy interrupted by oxygen, sulfur or by 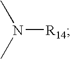
   C₆-C₉cycloalkylcarbonyl, C₆-C₉cycloalkylcarbonyloxy, benzoyl or C₁-C₁₂alkyl-substituted benzoyl; benzoyloxy or C₁-C₁₂alkyl-substituted benzoyloxy; 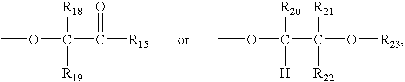
   or in formula II the radicals R₇ and R₈ or the radicals R₈ and R₁₁ together with the carbon atoms to which they are bonded form a benzo ring,
R₁₂ and R₁₃ are each independently of the other unsubstituted or C₁-C₄alkyl-substituted phenylene or naphthylene,
R₁₄ is hydrogen or C₁-C₈alkyl,
R₁₅ is hydroxy,

$$[ {—O}^{-} \frac{1}{r} {M}^{r +} ] ,$$

C₁-C₁₈alkoxy or 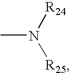
R₁₆ and R₁₇ are each independently of the other hydrogen, CF₃, C₁-C₁₂alkyl or phenyl, or R₁₆ and R₁₇ together with the carbon atom to which they are bonded form a C₅-C₈cycloalkylidene ring that is unsubstituted or substituted by from 1 to 3 C₁-C₄alkyl groups;
R₁₈ and R₁₉ are each independently of the other hydrogen, C₁-C₄alkyl or phenyl,
R₂₀ is hydrogen or C₁-C₄alkyl,
R₂₁ is hydrogen, unsubstituted or C₁-C₄alkyl-substituted phenyl; C₁-C₂₅alkyl, C₂-C₂₅alkyl interrupted by oxygen, sulfur or by 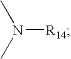
   C₇-C₉phenylalkyl that is unsubstituted or substituted on the phenyl radical by from 1 to 3 C₁-C₄alkyl groups; C₇C₂₅phenylalkyl that is unsubstituted or substituted on the phenyl radical by from 1 to 3 C₁-C₄alkyl groups and interrupted by oxygen, sulfur or by 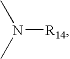
   or the radicals R₂₀ and R₂₁ together with the carbon atoms to which they are bonded form a C₅-C₁₂cycloalkylene ring that is unsubstituted or substituted by from 1 to 3 C₁-C₄alkyl groups;
R₂₂ is hydrogen or C₁-C₄alkyl,
R₂₃ is hydrogen, C₁-C₂₅alkanoyl, C₃-C₂₅alkenoyl, C₃-C₂₅alkanoyl interrupted by oxygen, sulfur or by 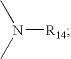
   C₂-C₂₅alkanoyl substituted by a di(C₁-C₆alkyl)phosphonate group; C₆-C₉cycloalkylcarbonyl, thenoyl, furoyl, benzoyl or C₁-C₁₂alkyl-substituted benzoyl; 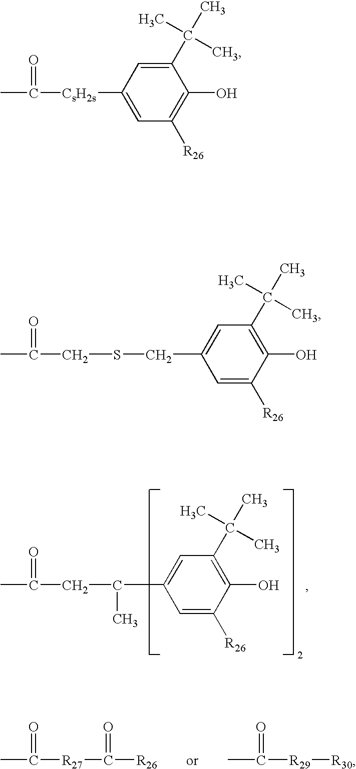
R₂₄ and R₂₅ are each independently of the other hydrogen or C₁-C₁₈alkyl,
R₂₆ is hydrogen or C₁-C₈alkyl,
R₂₇ is a direct bond, C₁-C₁₈alkylene, C₂-C₁₈alkylene interrupted by oxygen, sulfur or by 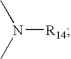
   C₂-C₁₈alkenylene, C₂-C₂₀alkylidene, C₇-C₂₀phenylalkylidene, C₅-C₈cycloalkylene, C₇-C₈bicycloalkylene, unsubstituted or C₁-C₄alkyl-substituted phenylene, 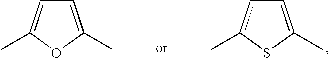
R₂₈ is hydroxy,

$$[ {—O}^{-} \frac{1}{r} {M}^{r +} ] ,$$

C₁-C₁₈alkoxy or 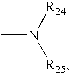
R₂₉ is oxygen, —NH— or 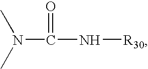
R₃₀ is C₁-C₁₈alkyl or phenyl,
R₃₁ is hydrogen or C₁-C₁₈alkyl,
M is an r-valent metal cation,
X is a direct bond, oxygen, sulfur or —NR₃₁—,
n is 1 or 2,
p is 0, 1 or 2,
q is 1, 2, 3, 4, 5 or 6,
r is 1, 2 or 3, and
s is 0,1 or 2.

Naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazoyl, furazanyl, biphenyl, terphenyl, fluorenyl or phenoxazinyl, each unsubstituted or substituted by C₁-C₄alkyl, C₁-C₄alkoxy, C₁-C₄alkylthio, hydroxy, halogen, amino, C₁-C₄alkylamino, phenylamino or by di(C₁-C₄alkyl)amino, is, for example, 1-naphthyl, 2-naphthyl, 1-phenylamino-4-naphthyl, 1-methylnaphthyl, 2-methylnaphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-phenoxathiinyl, 2,7-phenoxathiinyl, 2-pyrrolyl, 3-pyrrolyl, 5-methyl-3-pyrrolyl, 2-imidazolyl, 4-imidazolyl, 5-imidazolyl, 2-methyl-4imidazolyl, 2-ethyl-4-imidazolyl, 2-ethyl-5-imidazolyl, 3-pyrazolyl, 1-methyl-3-pyrazolyl, 1-propyl-4-pyrazolyl, 2-pyrazinyl, 5,6-dimethyl-2-pyrazinyl, 2-indolizinyl, 2-methyl-3-isoindolyl, 2-methyl-1-isoindolyl, 1-methyl-2-indolyl, 1-methyl-3-indolyl, 1,5-dimethyl-2-indolyl, 1-methyl-3-indazolyl, 2,7-dimethyl-8-purinyl, 2-methoxy-7-methyl-8-purinyl, 2-quinolizinyl, 3-isoquinolyl, 6-isoquinolyl, 7-isoquinolyl, isoquinolyl, 3-methoxy-6-isoquinolyl, 2-quinolyl, 6-quinolyl, 7-quinolyl, 2-methoxy-3-quinolyl, 2-methoxy-6-quinolyl, 6-phthalazinyl, 7-phthalazinyl, 1-methoxy-6-phthalazinyl, 1,4-dimethoxy-6-phthalazinyl, 1,8-naphthyridin-2-yl, 2-quinoxalinyl, 6-quinoxalinyl, 2,3-dimethyl-6-quinoxalinyl, 2,3-dimethoxy-6-quinoxalinyl, 2-quinazolinyl, 7-quinazolinyl, 2-dimethylamino-6-quinazolinyl, 3-cinnolinyl, 6-cinnolinyl, 7-cinnolinyl, 3-methoxy-7-cinnolinyl, 2-pteridinyl, 6-pteridinyl, 7-pteridinyl, 6,7-dimethoxy-2-pteridinyl, 2-carbazolyl, 3-carbazolyl, 9-methyl-2-carbazolyl, 9-methyl-3-carbazolyl, β-carbolin-3-yl, 1-methyl-β-carbolin-3-yl, 1-methyl-β-carbolin-6-yl, 3-phenanthridinyl, 2-acridinyl, 3-acridinyl, 2-perimidinyl, 1-methyl-5-perimidinyl, 5-phenanthrolinyl, 6-phenanthrolinyl, 1-phenazinyl, 2-phenazinyl, 3-isothiazolyl, 4-isothiazolyl, 5-isothiazolyl, 2-phenothiazinyl, 3-phenothiazinyl, 10-methyl-3-phenothiazinyl, 3-isoxazolyl, 4-isoxazolyl, 5-isoxazolyl, 4-methyl-3-furazanyl, 2-phenoxazinyl or 10-methyl-2-phenoxazinyl.

Special preference is given to naphthyl, phenanthryl, anthryl, 5,6,7,8tetrahydro-2-naphthyl, 5,6,7,8-tetrahydro-1-naphthyl, thienyl, benzo[b]thienyl, naphtho[2,3b]thienyl, thianthrenyl, dibenzofuryl, chromenyl, xanthenyl, phenoxathiinyl, pyrrolyl, isoindolyl, indolyl, phenothiazinyl, biphenyl, terphenyl, fluorenyl or phenoxazinyl, each unsubstituted or substituted by C₁-C₄alkyl, C₁-C₄alkoxy, C₁-C₄alkylthio, hydroxy, phenylamino or by di(C₁-C₄alkyl)amino, for example 1-naphthyl, 2-naphthyl, 1-phenylamino-4-naphthyl, 1-methylnaphthyl, 2-methylnaphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-pyrrolyl, 3-pyrrolyl, 2-phenothiazinyl, 3-phenothiazinyl, 10-methyl-3phenothiazinyl.

Halogen is, for example, chlorine, bromine or iodine. Chlorine is preferred.

Alkanoyl having up to 25 carbon atoms is a branched or unbranched radical, for example formyl, acetyl, propionyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, eicosanoyl or docosanoyl. Alkanoyl having from 2 to 18, especially from 2 to 12, e.g. from 2 to 6, carbon atoms is preferred. Acetyl is especially preferred.

C₂-C₂₅Alkanoyl substituted by a di(C₁-C₆alkyl)phosphonate group is, for example, (CH₃CH₂O)₂POCH₂CO—, (CH₃O)₂POCH₂CO—, (CH₃CH₂CH₂CH₂O)₂POCH₂CO—, (CH₃CH₂O)₂POCH₂CH₂CO—, (CH₃O)₂POCH₂CH₂CO—, (CH₃CH₂CH₂CH₂O)₂POCH₂CH₂CO—, (CH₃CH₂O)₂PO(CH₂)₄CO—, (CH₃CH₂O)₂PO(CH₂)₈CO— or (CH₃CH₂O)₂PO(CH₂)₁₇CO—.

Alkanoyloxy having up to 25 carbon atoms is a branched or unbranched radical, for example formyloxy, acetoxy, propionyloxy, butanoyloxy, pentanoyloxy, hexanoyloxy, heptanoyloxy, octanoyloxy, nonanoyloxy, decanoyloxy, undecanoyloxy, dodecanoyloxy, tridecanoyloxy, tetradecanoyloxy, pentadecanoyloxy, hexadecanoyloxy, heptadecanoyloxy, octadecanoyloxy, eicosanoyloxy or docosanoyloxy. Alkanoyloxy having from 2 to 18, especially from 2 to 12, e.g. from 2 to 6, carbon atoms is preferred. Acetoxy is especially preferred.

Alkenoyl having from 3 to 25 carbon atoms is a branched or unbranched radical, for example propenoyl, 2-butenoyl, 3-butenoyl, isobutenoyl, n-2,4-pentadienoyl, 3-methyl-2-butenoyl, n-2-octenoyl, n-2-dodecenoyl, isododecenoyl, oleoyl, n-2-octadecenoyl or n-4-octadecenoyl. Alkenoyl having from 3 to 18, especially from 3 to 12, e.g. from 3 to 6, more especially 3 or 4, carbon atoms is preferred.

C₃-C₂₅Alkenoyl interrupted by oxygen, sulfur or by 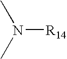
is, for example, CH₃OCH₂CH₂CH═CHCO— or CH₃OCH₂CH₂OCH═CHCO—.

Alkenoyloxy having from 3 to 25 carbon atoms is a branched or unbranched radical, for example propenoyloxy, 2-butenoyloxy, 3-butenoyloxy, isobutenoyloxy, n-2,4pentadienoyloxy, 3-methyl-2-butenoyloxy, n-2-octenoyloxy, n-2-dodecenoyloxy, isododecenoyloxy, oleoyloxy, n-2-octadecenoyloxy or n-4-octadecenoyloxy. Alkenoyloxy havng from 3 to 18, especially from 3 to 12, e.g. from 3 to 6, more especially 3 or 4, carbon atoms is preferred.

C₃-C₂₅Alkenoyloxy interrupted by oxygen, sulfur or by 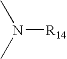
is, for example, CH₃OCH₂CH₂CH═CHCOO— or CH₃OCH₂CH₂OCH═CHCOO—.

C₃-C₂₅Alkanoyl interrupted by oxygen, sulfur or by 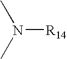
is, for example, CH₃—O—CH₂CO—, CH₃—S—CH₂CO—, CH₃—NH—CH₂CO—, CH₃—N(CH₃)—CH₂CO—, CH₃—O—CH₂CH₂—O—CH₂CO—, CH₃—(O—CH₂CH—)₂O—CH₂CO—, CH₃—(O—CH₂CH₂—)₃O—CH₂CO— or CH₃—(O—CH₂CH₂—)₄O—CH₂CO—.

C₃-C₂₅Alkanoyloxy interrupted by oxygen, sulfur or by 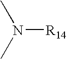
is, for example, CH₃—O—CH₂COO—, CH₃—S—C₂COO—, CH₃—NH—CH₂COO—, CH₃—N(CH₃)—CH₂COO—, CH₃—O—CH₂CH₂OCH₂COO—, CH₃—(O—CH₂CH₂—)₂O—CH₂COO—, CH₃—(O—CH₂CH₂—)₃O—CH₂COO— or CH₃—(O—CH₂CH₂—)₄O—CH₂COO—.

C₆-C₉Cycloalkylcarbonyl is, for example, cyclohexylcarbonyl, cycloheptylcarbonyl or cyclooctylcarbonyl. Cyclohexylcarbonyl is preferred.

C₆-C₉Cycloalkylcarbonyloxy is, for example, cyclohexylcarbonyloxy, cycloheptylcarbonyloxy or cyclooctylcarbonyloxy. Cyclohexylcarbonyloxy is preferred.

C₁-C₁₂Alkyl-substituted benzoyl, which preferably carries from 1 to 3, especially 1 or 2, alkyl groups, is, for example, o-, m- or p-methylbenzoyl, 2,3-dimethylbenzoyl, 2,4-dimethylbenzoyl, 2,5-dimethylbenzoyl, 2,6-dimethylbenzoyl, 3,4-dimethylbenzoyl, 3,5-dimethylbenzoyl, 2-methyl-6-ethylbenzoyl, 4-tert-butylbenzoyl, 2-ethylbenzoyl, 2,4,6-trimethylbenzoyl, 2,6-dimethyl-4-tert-butylbenzoyl or 3,5-di-tert-butylbenzoyl. Preferred substituents are C₁-C₈alkyl, especially C₁-C₄alkyl.

C₁-C₁₂Alkyl-substituted benzoyloxy, which preferably carries from 1 to 3, especially 1 or 2, alkyl groups, is, for example, o-, m- or p-methylbenzoyloxy, 2,3-dimethylbenzoyloxy, 2,4-dimethylbenzoyloxy, 2,5-dimethylbenzoyloxy, 2,6-dimethylbenzoyloxy, 3,4-dimethylbenzoyloxy, 3,5-dimethylbenzoyloxy, 2-methyl-6-ethylbenzoyloxy, 4-tert-butylbenzoyloxy, 2-ethylbenzoyloxy, 2,4,6-trimethylbenzoyloxy, 2,-dimethyl-4-tert-butylbenzoyloxy or 3,5-di-tert-butylbenzoyloxy. Preferred substituents are C₁-C₈alkyl, especially C₁-C₄alkyl.

Alkyl having up to 25 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. One of the preferred meanings of R₂ and R₄ is, for example, C₁-C₁₈alkyl. An especially preferred meaning of R₄ is C₁-C₄alkyl.

Alkenyl having from 3 to 25 carbon atoms is a branched or unbranched radical, for example propenyl, 2-butenyl, 3-butenyl, isobutenyl, n-2,4-pentadienyl, 3-methyl-2-butenyl, n-2-octenyl, n-2-dodecenyl, isododecenyl, oleyl, n-2-octadecenyl or n4-octadecenyl. Alkenyl having from 3 to 18, especially from 3 to 12, e.g. from 3 to 6, more especially 3 or 4, carbon atoms is preferred.

Alkenyloxy having from 3 to 25 carbon atoms is a branched or unbranched radical, for example propenyloxy, 2-butenyloxy, 3-butenyloxy, isobutenyloxy, n-2,4-pentadienyloxy, 3-methyl-2-butenyloxy, n-2-octenyloxy, n-2-dodecenyloxy, isododecenyloxy, oleyloxy, n-2-octadecenyloxy or n-4-octadecenyloxy. Alkenyloxy having from 3 to 18, especially from 3 to 12, e.g. from 3 to 6, more especially 3 or 4, carbon atoms is preferred.

Alkynyl having from 3 to 25 carbon atoms is a branched or unbranched radical, for example propynyl(—CH₂—C≡CH), 2-butynyl, 3-butynyl, n-2-octynyl or n-2-dodecynyl. Alkynyl having from 3 to 18, especially from 3 to 12, e.g. from 3 to 6, more especially 3 or 4, carbon atoms is preferred.

Alkynyloxy having from 3 to 25 carbon atoms is a branched or unbranched radical, for example propynyloxy(—OCH₂—C≡CH), 2-butynyloxy, 3-butynyloxy, n-2-octynyloxy or n-2-dodecynyloxy. Alkynyloxy having from 3 to 18, especially from 3 to 12, e.g. from 3 to 6, moe especially 3 or 4, carbon atoms is preferred.

C₂-C₂₅Alkyl interrupted by oxygen, sulfur or by 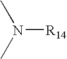
is, for example, CH₃—O—CH₂—, CH₃—S—CH₂—, CH₃—NH—CH₂—, CH₃—N(CH₃)—CH₂—, CH₃—O—CH₂CH₂—O—CH₂—, CH₃—(O—CH₂CH₂)₂O—CH₂—, CH₃—(O—CH₂CH₂—)₃O—CH₂— or CH₃—(O—CH₂CH₂—)₄O—CH₂—.

C₇-C₉Phenylalkyl is, for example, benzyl, α-methylbenzyl, α,α-dimethylbenzyl or 2-phenylethyl. Benzyl and α,α-dimethylbenzyl are preferred.

C₇-C₉Phenylalkyl that is unsubstituted or substituted on the phenyl radical by from 1 to 3 C₁-C₄alkyl groups is, for example, benzyl, α-methylbenzyl, α,α-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. Benzyl is preferred.

C₇-C₂₅Phenylalkyl unsubstituted or substituted on the phenyl radical by from 1 to 3 C₁-C₄alkyl groups and interrupted by oxygen, sulfur or by 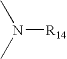
is a branched or unbranched radical, for example phenoxymethyl, 2-methyl-phenoxymethyl, 3-methyl-phenoxymethyl, 4-methyl-phenoxymethyl, 2,4-dimethyl-phenoxymethyl, 2,3-dimethyl-phenoxymethyl, phenylthiomethyl, N-methyl-N-phenyl-aminomethyl, N-ethyl-N-phenyl-aminomethyl, 4-tert-butylphenoxymethyl, 4-tert-butyl-phenoxyethoxy-methyl, 2,4-di-tert-butyl-phenoxymethyl, 2,4-di-tert-butyl-phenoxyethoxymethyl, phenoxyethoxyethoxyethoxymethyl, benzyloxymethyl, benzyloxyethoxymethyl, N-benzyl-N-ethyl-aminomethyl or N-benzyl-N-isopropyl-aminomethyl.

C₇-C₉Phenylalkoxy is, for example, benzyloxy, α-methylbenzyloxy, α,α-dimethylbenzyloxy or 2-phenylethoxy. Benzyloxy is preferred.

C₁-C₄Alkyl-substituted phenyl, which contains preferably from 1 to 3, especially 1 or 2, alkyl groups, is, for example, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl 2-ethylphenyl or 2,6-diethylphenyl.

C₁-C₄Alkyl-substituted phenoxy, which contains preferably from 1 to 3, especially 1 or 2, alkyl groups, is, for example, o-, m- or p-methylphenoxy, 2,3-dimethylphenoxy, 2,4-dimethylphenoxy, 2,5-dimethylphenoxy, 2,6-dimethylphenoxy, 3,4-dimethylphenoxy, 3,5-dimethylphenoxy, 2-methyl-ethylphenoxy, 4-tert-butylphenoxy, 2-ethylphenoxy or 2,6-diethylphenoxy.

Unsubstituted or C₁-C₄alkyl-substituted C₅C₈cycloalkyl is, for example, cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. Cyclohexyl and tert-butylcyclohexyl are preferred.

Unsubstituted or C₁-C₄alkyl-substituted C₅-C₈cycloalkoxy is, for example, cyclopentyloxy, methylcyclopentyloxy, dimethylcyclopentyloxy, cyclohexyloxy, methylcyclohexyloxy, dimethylcyclohexyloxy, trimethylcyclohexyloxy, tert-butylcyclohexyloxy, cycloheptyloxy or cyclooctyloxy. Cyclohexyloxy and tert-butylcyclohexyloxy are preferred.

Alkoxy having up to 25 carbon atoms is a branched or unbranched radical, for example methoxy, ethoxy, propoxy, isopropoxy, n-butoxy, isobutoxy, pentyloxy, isopentyloxy, hexyloxy, heptyloxy, octyloxy, decyloxy, tetradecyloxy, hexadecyloxy or octadecyloxy. Alkoxy having from 1 to 12, especially from 1 to 8, e.g. from 1 to 6, carbon atoms is preferred.

C₂-C₂₅Alkoxy interrupted by oxygen, sulfur or by 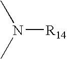
is, for example, CH₃—O—CH₂CH₂O—, CH₃—S—CH₂CH₂O—, CH₃—NH—CH₂CH₂O—, CH₃—N(CH₃)—CH₂CH₂O—, CH₃—O—CH₂CH₂—O—CH₂CH₂O—, CH₃—(O—CH₂CH₂—)₂O—CH₂CH₂O—, CH₃—(O—CH₂CH₂—)₃O—CH₂CH₂O— or CH₃—(O—CH₂CH₂)₄O—CH₂CH₂O—.

Alkylthio having up to 25 carbon atoms is a branched or unbranched radical, for example methylthio, ethylthio, propylthio, isopropylthio, n-butylthio, isobutylthio, pentylthio, isopentylthio, hexylthio, heptylthio, octylthio, decylthio, tetradecylthio, hexadecylthio or octadecylthio. Alkylthio having from 1 to 12, especially from 1 to 8, e.g. from 1 to 6, carbon atoms is preferred.

Alkylamino having up to 4 carbon atoms is a branched or unbranched radical, for example methylamino, ethylamino, propylamino, isopropylamino, n-butylamino, isobutylamino or tert-butylamino.

Di(C₁-C₄alkyl)amino means that the two radicals are each independently of the other branched or unbranched, for example dimethylamino, methylethylamino, diethylamino, methyl-n-propylamino, methylisopropylamino, methyl-n-butylamino, methylisobutylamino, ethylisopropylamino, ethyl-n-butylamino, ethylisobutylamino, ethyl-tert-butylamino, diethylamino, diisopropylamino, isopropyl-n-butylamino, isopropylisobutylamino, di-n-butylamino or diisobutylamino.

Alkanoylamino having up to 25 carbon atoms is a branched or unbranched radical, for example formylamino, acetylamino, propionylamino, butanoylamino, pentanoylamino, hexanoylamino, heptanoylamino, octanoylamino, nonanoylamino, decanoylamino, undecanoylamino, dodecanoylamino, tridecanoylamino, tetradecanoylamino, pentadecanoylamino, hexadecanoylamino, heptadecanoylamino, octadecanoylamino, eicosanoylamino or docosanoylamino. Alkanoylamino having from 2 to 18, especially from 2 to 12, e.g. from 2 to 6, carbon atoms is preferred.

C₁-C₁₈Alkylene is a branched or unbranched radical, for example methylene, ethylene, propylene, trimethylene, tetramethylene, pentamethylene, hexamethylene, heptamethylene, octamethylene, decamethylene, dodecamethylene or octadecamethylene. C₁-C₁₂Alkylene, especially C₁-C₈alkylene, is preferred.

An unsubstituted or C₁-C₄alkyl-substituted C₅-C₁₂cycloalkylene ring, which preferably contains from 1 to 3, especially 1 or 2, branched or unbranched alkyl groups, is, for example, cyclopentylene, methylcyclopentylene, dimethylcyclopentylene, cyclohexylene, methylcyclohexylene, dimethylcyclohexylene, trimethylcyclohexylene, tert-butylcyclohexylene, cycloheptylene, cyclooctylene or cyclodecylene. Cyclohexylene and tert-butylcyclohexylene are preferred.

C₂-C₁₈Alkylene interrupted by oxygen, sulfur or by 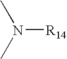
is, for example, —CH₂—O—CH₂—, —CH₂—S—CH₂—, —CH₂—NH—CH₂—, —CH₂—N(CH₃CH₂—, —CH₂—O—CH₂CH₂—O—CH₂—, —CH₂—(O—CH₂CH₂)₂O—CH₂—, —CH₂—(O—CH₂CH₂)₃O—CH₂, —CH₂—(O—CH₂CH₂—)₄O—CH₂— or —CH₂CH₂—S—CH₂CH₂—.

C₂-C₁₈Alkenylene is, for example, vinylene, methylvinylene, octenylethylene or dodecenylethylene. C₂-C₈Alkenylene is preferred.

Alkylidene having from 2 to 20 carbon atoms is, for example, ethylidene, propylidene, butylidene, pentylidene, 4-methylpentylidene, heptylidene, nonylidene, tridecylidene, nonadecylidene, 1-methylethylidene, 1-ethylpropylidene or 1-ethylpentylidene. C₂-C₈Alkylidene is preferred.

Phenylalkylidene having from 7 to 20 carbon atoms is, for example, benzylidene, 2-phenylethylidene or 1-phenyl-2-hexylidene. C₇-C₉Phenylalkylidene is preferred.

C₅-C₈Cycloalkylene is a saturated hydrocarbon group having two free valencies and at least one ring unit and is, for example, cyclopentylene, cyclohexylene, cycloheptylene or cyclooctylene. Cyclohexylene is preferred.

C₇-C₈Bicycloalkylene is, for example, bicycloheptylene or bicyclooctylene.

Unsubstituted or C₁-C₄alkyl-substituted phenylene or naphthylene is, for example, 1,2-, 1,3-, 1,4phenylene, 1,2-, 1,3-, 1,4-, 1,6-, 1,7-, 2,6 or 2,7-naphthylene. 1,4-Phenylene is preferred.

An unsubstituted or C₁-C₄alkyl-substituted C₅-C₈cycloalkylidene ring, which contains preferably from 1 to 3, especially 1 or 2, branched or unbranched alkyl groups, is, for example, cyclopentylidene, methylcyclopentylidene, dimethylcyclopentylidene, cyclohexylidene, methylcyclohexylidene, dimethylcyclohexylidene, trimethylcyclohexylidene, tert-butylcyclohexylidene, cycloheptylidene or cyclooctylidene. Cyclohexylidene and tert-butylcyclohexylidene are preferred.

A mono-, di- or tri-valent metal cation is preferably an alkali metal, alkaline earth metal or aluminium cation, for example Na⁺, K⁺, Mg⁺⁺, Ca⁺⁺ or Al⁺⁺⁺.

Preferred benzofuran-2-ones are those of formula (I) wherein, when n is 1, R₁ is phenyl unsubstituted or substituted in the para-position by C₁-C₁₈akylthio or by di(C₁-C₄alkyl)amino; mono- to penta-substituted alkylphenyl having a sum total of a maximum of 18 carbon atoms in its 1 to 5 alkyl substituents; or naphthyl, biphenyl, terphenyl, phenanthryl, anthryl, fluorenyl, carbazolyl, thienyl, pyrrolyl, phenothiazinyl or 5,6,7,8-tetrahydronaphthyl, each unsubstituted or substituted by C₁-C₄alkyl, C₁-C₄alkoxy, C₁-C₄alkylthio, hydroxy or by amino.

Preference is also given to benzofuran-2-ones of formula I wherein, when n is 2,
R₁ is —R₁₂—X—R₁₃—,
R₁₂ and R₁₃ are phenylene,
X is oxygen or —NR₃₁—, and
R₃₁ is C₁-C₄alkyl.

A group of benzofuran-2-ones that is likewise preferred comprises those of formula I wherein, when n is 1,
R₁ is naphthyl, phenanthryl, thienyl, dibenzofuryl, carbazolyl or fluorenyl, each unsubstituted or substituted by C₁-C₄alkyl, C₁-C₄alkoxy, C₁-C₄alkylthio, hydroxy, halogen, amino, C₁-C₄-alkylamino or by di(C₁-C₄alkyl)amino, or is a radical of formula II 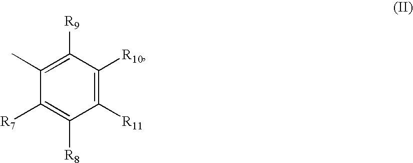
R₇, R₈, R₉, R₁₀ and R₁₁ are each independently of the others hydrogen, chlorine, bromine, hydroxy, C₁-C₁₈alkyl, is alkyl interrupted by oxygen or by sulfur; C₁-C₁₈alkoxy, C₂-C₁₈alkoxy interrupted by oxygen or by sulfur; C₁-C₁₈akylthio, C₃-C₁₂alkenyloxy, C₃-C₁₂-alkynyloxy, C₇-C₉phenylalkyl, C₇-C₉phenylalkoxy, unsubstituted or C₁-C₄alkyl-substituted phenyl; phenoxy, cyclohexyl, C₅-C₈cycloalkoxy, C₁-C₄alkylamino, di(C₁-C₄alkyl)amino, C₁-C₁₂alkanoyl, C₃-C₁₂alkanoyl interrupted by oxygen or by sulfur; C₁-C₁₂alkanoyloxy, C₃-C₁₂alkanoyloxy interrupted by oxygen or by sulfur; C₁-C₁₂alkanoylamino, C₃-C₁₂alkenoyl, C₃-C₁₂alkenoyloxy, cyclohexylcarbonyl, cyclohexylcarbonyloxy, benzoyl or C₁-C₄alkyl-substituted benzoyl; benzoyloxy or C₁-C₄alkyl-substituted benzoyloxy; 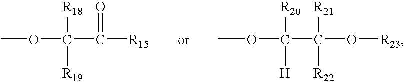
   or in formula II the radicals R₇ and R₈ or the radicals R₈ and R₁₁ together with the carbon atoms to which they are bonded form a benzo ring,
R₁₅ is hydroxy, C₁-C₁₂alkoxy or 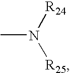
R₁₈ and R₁₉ are each independently of the other hydrogen or C₁-C₄alkyl,
R₂₀ is hydrogen,
R₂₁ is hydrogen, phenyl, C₁-C₁₈alkyl, C₂-C₁₈alkyl interrupted by oxygen or by sulfur; C₇-C₉-phenylalkyl, or C₇-C₁₈phenylalkyl unsubstituted or substituted on the phenyl radical by from 1 to 3 C₁-C₄alkyl groups and interrupted by oxygen or by sulfur, or the radicals R₂₀ and R₂₁ together with the carbon atoms to which they are bonded form a cyclohexylene ring that is unsubstituted or substituted by from 1 to 3 C₁-C₄alkyl groups,
R₂₂ is hydrogen or C₁-C₄alkyl,
R₂₃ is hydrogen, C₁-C₁₈alkanoyl, C₃-C₁₈alkenoyl, C₃-C₁₂alkanoyl interrupted by oxygen or by sulfur; C₂-C₁₂alkanoyl substituted by a di(C₁-C₆alkyl)phosphonate group; C₆-C₉cycloalkylcarbonyl, benzoyl, 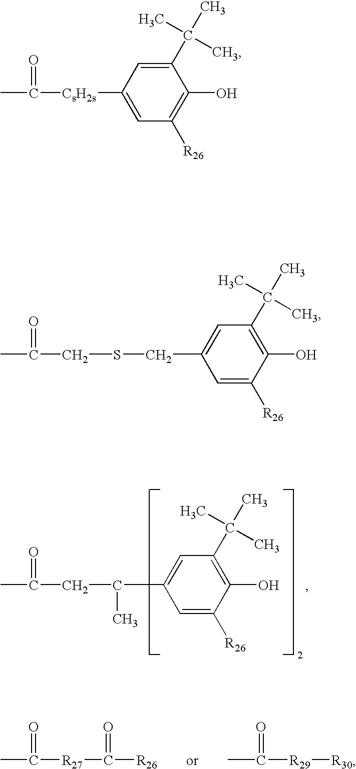
R₂₄ and R₂₅ are each independently of the other hydrogen or C₁-C₁₂alkyl,
R₂₆ is hydrogen or C₁-C₄alkyl,
R₂₇ is C₁-C₁₂alkylene, C₂-C₈alkenylene, C₂-C₈alkylidene, C₇-C₁₂phenylalkylidene, C₅-C₈-cycloalkylene or phenylene,
R₂₈ is hydroxy, C₁-C₁₂alkoxy or 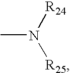
R₂₉ is oxygen or —NH—,
R₃₀ is C₁-C₁₈alkyl or phenyl, and
s is 1 or 2.

Preference is also given to benzofuran-2-ones of formula I wherein, when n is 1,
R₁ is phenanthryl, thienyl, dibenzofuryl, unsubstituted or C₁-C₄alkyl-substituted carbazolyl; or fluorenyl; or R₁ is a radical of formula II 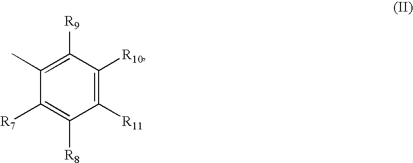
R₇, R₈, R₉, R₁₀ and R₁₁ are each independently of the others hydrogen, chlorine, hydroxy, C₁-C₁₈alkyl, C₁-C₁₈alkoxy, C₁-C₁₈akylthio, C₃-C₄alkenyloxy, C₃-C₄alkynyloxy, phenyl, benzoyl, benzoyloxy or 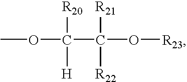
R₂₀ is hydrogen,
R₂₁ is hydrogen, phenyl or C₁-C₁₈alkyl, or the radicals R₂₀ and R₂₁ together with the carbon atoms to which they are bonded form a cyclohexylene ring that is unsubstituted or substituted by from 1 to 3 C₁-C₄alkyl groups,
R₂₂ is hydrogen or C₁-C₄alkyl, and
R₂₃ is hydrogen, C₁-C₁₂alkanoyl or benzoyl.

Special preference is given to benzofuran-2-ones of formula I wherein, when n is 1,
R₇, R₈, R₉, R₁₀ and R₁₁ are each independently of the others hydrogen, C₁-C₁₂alkyl, C₁-C₄alkylthio or phenyl.

Of special interest are benzofuran-2-ones of formula I wherein
R₂, R₃, R₄ and R₅ are each independently of the others hydrogen, chlorine, C₁-C₁₈alkyl, benzyl, phenyl, C₅-C₈cycloalkyl, C₁-C₁₈alkoxy, C₁-C₁₈alkylthio, C₁-C₁₈alkanoyloxy, C₁-C₁₈-alkanoylamino, C₃-C₁₈alkenoyloxy or benzoyloxy; or the radicals R₂ and R₃ or the radicals R₃ and R₄ or the radicals R₄ and R₅ together with the carbon atoms to which they are bonded form a benzo ring, or R₄ may additionally be —(CH₂)ₚ—COR₁₅ or —(CH₂)_{q}OH, or when R₃, R₅ and R₆ are hydrogen, R₄ may additionally be a radical of formula III,
R₁₅ is hydroxy, C₁-C₁₂alkoxy or 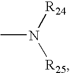
R₁₆ and R₁₇ are methyl groups or together with the carbon atom to which they are bonded form a C₅-C₈cycloalkylidene ring that is unsubstituted or substituted by from 1 to 3 C₁-C₄alkyl groups,
R₂₄ and R₂₅ are each independently of the other hydrogen or C₁-C₁₂alkyl,
p is 1 or 2, and
q is 2, 3, 4, 5 or 6.

Also of special interest are benzofuran-2-ones of formula I wherein at least two of the radicals R₂, R₃, R₄ and R₅ are hydrogen.

Especially interesting compositions are those comprising as component (c) (i) at least one compound of formula I wherein R₃ and R₅ are hydrogen.

Very special preference is given to benzofuran-2-ones of formula I wherein
R₂ is C₁-C₄alkyl,
R₃ is hydrogen,
R₄ is C₁-C₄alkyl or, when R₆ is hydrogen, R₄ may additionally be a radical of formula III,
R₅ is hydrogen, and
R₁₆ and R₁₇ together with the carbon atom to which they are bonded form a cyclohexylidene ring.

The following compounds are examples of the benzofuran-2-one type that are especially suitable as component (b) in the composition according to the invention: 3-[4(2-acetoxyethoxy)phenyl]-5,7-di-tert-butyl-benzofuran-2-one; 5,7-di-tert-butyl-3-[4-(2-stearoyloxyethoxy)phenyl]-benzofuran-2-one; 3,3′-bis[5,7-di-tert-butyl-3-(4-[2-hydroxyethoxy]phenyl)benzofuran-2-one]; 5,7-di-tert-butyl-3-(4-ethoxyphenyl)benzofuran-2-one; 3-(4-acetoxy-3,5-dimethylphenyl)-5,7-di-tert-butyl-benzofuran-2-one; 3-(3,5-dimethyl-4-pivaloyloxy-phenyl)-5,7-di-tert-butyl-benzofuran-2-one; 5,7-di-tert-butyl-3-phenyl-benzofuran-2-one; 5,7-di-tert-butyl-3-(3,4-dimethylphenyl)-benzofuran-2-one; 5,7-di-tert-butyl-3-(2,3-dimethylphenyl)benzofuran-2-one.

Very special preference is given to benzofuran-2-ones of formula V 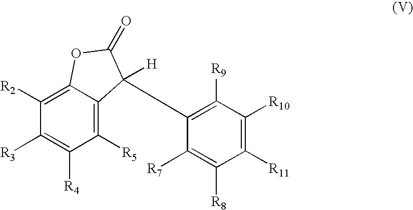
wherein
R₂ is hydrogen or C₁-C₆alkyl,
R₃ is hydrogen,
R₄ is hydrogen or C₁-C₆alkyl,
R₅ is hydrogen,
R₇, R₈, R₉, R₁₀ and R₁₁ are each independently of the others hydrogen, C₁-C₄alkyl, C₁-C₄-alkoxy or 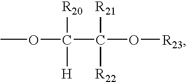
   with the proviso that at least two of the radicals R₇, R₈, R₉, R₁₀ and R₁₁ are hydrogen,
R₂₀, R₂₁, and R₂₂ are hydrogen, and
R₂₃ is C₂-C₄alkanoyl.

Special preference is given to benzofuran-2ones of formula Va or Vb 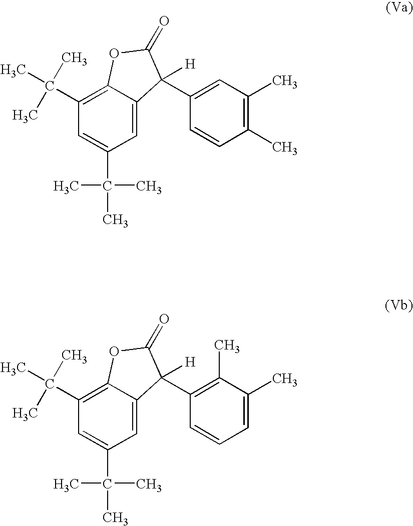
or a mixture of the two compounds of formulae Va and Vb.

The compounds of the benzofuran-2-one type as component (b) are known in the literature and the preparation thereof is described, for example, in U.S. Pat. No. 5,516,920.

Component (b) is added preferably in an amount of from 0.0001 to 10% by weight, especially from 0.001 to 7% by weight and more especially from 0.002 to 5% by weight, based on the monomer, oligomer, co-oligomer, polymer or copolymer.

If a mixture of a stable sterically hindered nitroxyl free-radical and a compound of the benzofuran-2one type is used, the ratio by weight is preferably from 1:10 to 10:1.

The invention relates also to a method of increasing the storage stability and preventing premature polymerisation or crosslinking of
a1) at least one oligomer, co-oligomer, polymer or copolymer or a mixture thereof having at least one ethylenically unsaturated bond; or
a2) a mixture of at least one ethylenically unsaturated monomer with at least one oligomer, co-oligomer, polymer or copolymer having at least one ethylenically unsaturated bond, which method comprises adding at least one stable sterically hindered nitroxyl free-radical or at least one compound of the benzofuran-2-one type or a mixture of the two compounds.

The present invention relates also to the use of a stable sterically hindered nitroxyl free-radical or a compound of the benzofuran-2-one type or a mixture of the two compounds for increasing the storage stability and preventing premature polymerisation or crosslinking of
a1) at least one oligomer, co-oligomer, polymer or copolymer or a mixture thereof having at least one ethylenically unsaturated bond; or
a2) a mixture of at least one ethylenically unsaturated monomer with at least one oligomer, co-oligomer, polymer or copolymer having at least one ethylenically unsaturated bond.

The definitions and preferred meanings mentioned above apply also to the claimed method and to the use of the stabilisers.

The following Examples illustrate the invention.

### EXAMPLE 1

TABLE 1
Composition of the coating

| | |
|---|---|
| 51 parts | aliphatic urethane diacryltate Ebecryl ® 4858 |
| | (UCB Chemicals) unstabilised |
| 10 parts | tripropylene glycol diacrylate (UCB Chemicals) unstabilised |
| 13 parts | trimethylolpropane triacrylate (UCB Chemicals) unstabilised |
| 0.5 part | Byk ® 300 flow-control agent (Byk-Chemie) |
| 0.22 part | Irgacure ® 819 bisacylphosphine oxide |
| | (Ciba Spezialitäten Chemie AG) |
| 2 parts | Irgacure 184 ® α-hydroxyketone (Ciba Spezialitäten |
| | Chemie AG) |

The stabilisers indicated in Tables 2 and 3 and optionally light stabilisers are incorporated into the composition described above. The formulations are applied with a doctor blade to a white coil-coated aluminium sheet so that a dry film thickness of 45 μm is obtained. The coating film is cured using 2×120 W/cm medium-pressure mercury vapour lamps at 5 m/min. The sheet is divided into three parts.

One part is left without after-treatment, while the second part is again irradiated with 2×120 W/cm. The third part is stored in a circulating-air oven for 30 min at 130° C.

The samples are then left at room temperature for 15 min and 4 h after the curing and the after-treatment, and the yellowing b* according to DIN 6174 of each sample is measured. A higher b* value indicates a higher degree of yellowing. The results are shown in Tables 2 and 3.

TABLE 2
b* value according to DIN 6174

| | | | | 0.02% | 0.02% |
|---|---|---|---|---|---|
| | without | 0.02% | 0.02% | Comp. | Comp. |
| Treatment | additive | toluquinone | Comp. 101 | 201 | 102 |
| 1 × 5 m/min | | | | | |
| 15 min | 4.2 | 4.5 | 4.4 | 4.4 | 4.1 |
| 4 h | 3.4 | 3.8 | 3.7 | 3.7 | 3.5 |
| 2 × 5 m/min | | | | | |
| 15 min | 4.7 | 4.9 | 4.6 | 4.8 | 4.7 |
| 4 h | 4.0 | 4.2 | 4.0 | 4.1 | 4.0 |
| 30 min 130° C. | | | | | |
| 15 min | 1.0 | 1.3 | 0.9 | 1.1 | 1.1 |
| 4 h | 1.1 | 1.3 | 0.9 | 1.2 | 1.2 |

TABLE 3
b* value according to DIN 6174

| | | | | 0.02% | 0.02% |
|---|---|---|---|---|---|
| | without | 0.02% | 0.02% | Comp. | Comp. |
| Treatment | additive | toluquinone | Comp. 101 | 201 | 102 |
| 1 × 5 m/min | | | | | |
| 15 min | 3.4 | 3.5 | 3.2 | 3.4 | 3.3 |
| 4 h | 2.9 | 3.1 | 2.9 | 3.0 | 2.9 |
| 2 × 5 m/min | | | | | |
| 15 min | 4.2 | 4.4 | 4.1 | 4.3 | 4.2 |
| 4 h | 3.7 | 3.9 | 3.7 | 3.8 | 3.7 |
| 30 min 130° C. | | | | | |
| 15 min | 2.4 | 2.6 | 2.2 | 2.3 | 2.5 |
| 4 h | 2.5 | 2.7 | 2.3 | 2.4 | 2.6 |

All formulations in Table 3 contain additional light stabilisers: 1.5% Tinuvin® 400+1.0% Tinuvin® 292 (% by weight, based on monomer and oligomer).

The storage stability of the stabilised samples in Tables 2 and 3 is more than 3 months at 60° C.

### EXAMPLE 2

TABLE 4
Composition of the coating

| | |
|---|---|
| 51 parts | aliphatic urethane hexaacrylate Ebecryl ® 1290 |
| | (UCB Chemicals) unstabilised |
| 30 parts | isopropanol (Fluka Chemicals) |
| 13 parts | trimethylolpropane triacrylate (UCB Chemicals) unstabilised |
| 0.19 part | Irgacure ® 819 bisacylphosphine oxide |
| | (Ciba Spezialitäten Chemie AG) |
| 1.73 parts | Irgacure ® 184 α-hydroxyketone (Ciba Spezialitäten |
| | Chemie AG) |

The samples are prepared and treated and their yellowing measured as described in Example 1. The results are shown in Tables 5 and 6.

TABLE 5
b* value according to DIN 6174

| | | | 0.02% | 0.02% | 0.01% |
|---|---|---|---|---|---|
| | without | 0.02% | Comp. | Comp. | MEHQ + 0.1% |
| | additive | toluquinone | 101 | 102 | Comp. 101 |
| 1 × 5 m/min | | | | | |
| 15 min | 6.3 | 6.6 | 6.3 | 6.3 | 6.2 |
| 4 h | 5.6 | 6 | 5.6 | 5.6 | 5.5 |
| 2 × 5 m/min | | | | | |
| 15 min | 7.4 | 7.8 | 7.4 | 7.2 | 7.3 |
| 4 h | 6.6 | 7 | 6.6 | 6.4 | 6.5 |
| 30 min | | | | | |
| 130° C. | | | | | |
| 15 min | 4 | 4.6 | 4 | 4.3 | 3.9 |
| 4 h | 3.7 | 3.9 | 3.4 | 3.7 | 3.2 |

MEHQ = hydroquinone monomethyl ether = 4-methoxyphenol

TABLE 6
b* value according to DIN 6174

| | | | 0.02% | 0.02% | 0.01% |
|---|---|---|---|---|---|
| | without | 0.02% | Comp. | Comp. | MEHQ + 0.1% |
| | additive | toluquinone | 101 | 102 | Comp. 101 |
| 1 × 5 m/min | | | | | |
| 15 min | 6 | 6.3 | 6.1 | 6.2 | 6.2 |
| 4 h | 5 | 5.3 | 5 | 5.1 | 5.1 |
| 2 × 5 m/min | | | | | |
| 15 min | 7.5 | 7.9 | 7.6 | 7.7 | 7.6 |
| 4 h | 6.6 | 6.8 | 6.6 | 6.8 | 6.6 |
| 30 min | | | | | |
| 130° C. | | | | | |
| 15 min | 3.5 | 3.7 | 3.3 | 3.5 | 3.4 |
| 4 h | 3.5 | 3.6 | 3.3 | 3.4 | 3.4 |

MEHQ = hydroquinone monomethyl ether = 4-methoxyphenol

All formulations in Table 6 contain additional light stabilisers: 1.5% Tinuvin® 400+1.0% Tinuvin® 292 (% by weight, based on monomer and oligomer).

The storage stability of the stabilised samples in Tables 5 and 6 is more than 3 months at 60° C.

Irgacure® 819 and Irgacure® 184 are photoinitiators of Ciba Spezialitätenchemie;

Tinuvin® 400 and Tinuvin® 292 are light stabilisers of Ciba Spezialitätenchemie;

Comp. 201 is a mixture of

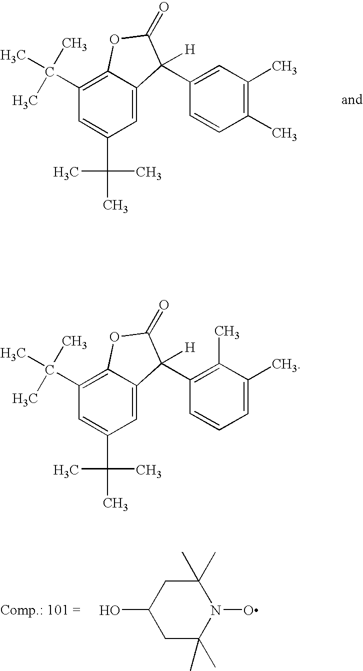

Comp.: 102=bis(1oxy-2,2,6,6-tetramethylpiperidin-4-yl)sebacate (Prostab ®5415, Ciba Spezialitäten Chemie)

1-11. (canceled)

12. A method of increasing the storage stability and preventing yellowing under the action of UV-light, of an UV-curable composition comprising
a1) at least one oligomer, co-oligomer, polymer or copolymer or a mixture thereof having at least one ethylenically unsaturated bond; or
a2) a mixture of at least one ethylenically unsaturated monomer with at least one oligomer, co-oligomer, polymer or copolymer having at least one ethylenically unsaturated bond, and
one or more photoinitiators,
which method comprises adding at least one stable sterically hindered nitroxyl free-radical or at least one compound of the benzofuran-2-one type or a mixture of the two compounds,
and wherein the storage stability of the composition is greater than 3 months at 60° C., as measured by having a change in viscosity of about 2% or less according to DIN53019.

13. A method according to claim 12, wherein the monomer, oligomer, co-oligomer, polymer or copolymer has at least 2-ethylenically unsaturated bonds.

14. A method according to claim 12, wherein the monomer, oligomer, co-oligomer, polymer or copolymer contains at least one acrylate or methacrylate functionality or is a polyester derived from an unsaturated acid.

15. A method according to claim 12, wherein the stable sterically hindered nitroxyl free-radicals have the following structural feature, 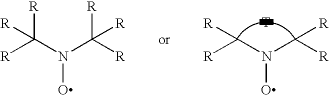
wherein R is alkyl and T is a group required to complete a 5- or 6-membered ring.

16. A method according to claim 12, wherein the stable sterically hindered nitroxyl free-radicals are selected from the group consisting of bis(1-oxy-2,2,6,6-tetramethylpiperidin-4-yl)sebacate, 4-hydroxy-1-oxy-2,2,6,6-tetramethylpiperidine, 4-ethoxy-1-oxy-2,2,6,6-tetramethylpiperidine, 4-propoxy-1-oxy-2,2,6,6-tetramethylpiperidine, 4-acetamido-1-oxy-2,2,6,6-tetramethylpiperidine, 1-oxy-2,2,6,6-tetramethylpiperidine, 1-oxy-2,2,6,6-tetramethylpiperidin-4-one, 1-oxy-2,2,6,6-tetramethylpiperidin-4-yl acetate, 1-oxy-2,2,6,6-tetramethylpiperidin-4-yl 2-ethylhexanoate, 1-oxy-2,2,6,6-tetramethylpiperidin-4-yl stearate, 1-oxy-2,2,6,6-tetramethylpiperidin-4-yl benzoate, 1-oxy-2,2,6,6-tetramethylpiperidin-4-yl 4-tert-butyl-benzoate, bis(1-oxy-2,2,6,6-tetramethylpiperidin-4-yl)succinate, bis(1-oxy-2,2,6,6-tetramethylpiperidin-4-yl)adipate, bis(1-oxy-2,2,6,6-tetramethylpiperidin-4-yl)n-butylmalonate, bis(1-oxy-2,2,6,6-tetramethylpiperidin-4-yl)phthalate, bis(1-oxy-2,2,6,6-tetramethylpiperidin-4-yl) isophthalate, bis(1-oxy-2,2,6,6-tetramethylpiperidin-4-yl)terephthalate, bis(1-oxy-2,2,6,6-tetramethylpiperidin-4-yl)hexahydroterephthalate, N,N′-bis(1-oxy-2,2,6,6-tetramethylpiperidin-4-yl)adipamide, N-(1-oxy-2,2,6,6-tetramethylpiperidin-4-yl)caprolactam, N-(1-oxy-2,2,6,6-tetramethylpiperidin-4-yl)dodecylsuccinimide, 2,4,6-tris[N-butyl-N-(1-oxy-2,2,6,6-tetramethylpiperidin-4-yl)]-s-triazine, 4,4′-ethylenebis(1-oxy-2,2,6,6-tetramethylpiperazin-3-one), 2-oxy-1,1,3,3-tetramethyl-2-isobenzazole, 1-oxy-2,2,5,5-tetramethylpyrrolidine and N,N-bis(1,1,3,3-tetramethylbutyl)nitroxide.

17. A method according to claim 12, comprising as component of the benzofuran-2-one type a compound of formula I 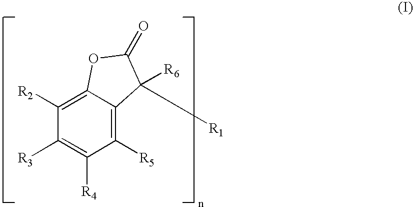
wherein, when n is 1,
R₁ is naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, each unsubstituted or substituted by C₁-C₄alkyl, C₁-C₄alkoxy, C₁-C₄alkylthio, hydroxy, halogen, amino, C₁-C₄alkylamino, phenylamino or by di(C₁-C₄alkyl)amino, or R₁ is a radical of formula II 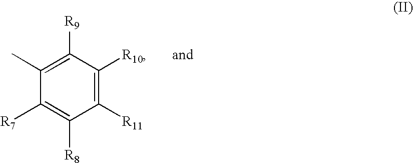
when n is 2,
R₁ is phenylene or naphthylene, each unsubstituted or substituted by C₁-C₄alkyl or by hydroxy; or is —R₁₂—X—R₁₃—,
R₂, R₃, R₄ and R₅ are each independently of the others hydrogen, chlorine, hydroxy, C₁-C₂₅alkyl, C₇-C₉phenylalkyl, unsubstituted or C₁-C₄alkyl-substituted phenyl; unsubstituted or C₁-C₄alkyl-substituted C₅-C₈cycloalkyl; C₁-C₁₈alkoxy, C₁-C₁₈alkylthio, C₁-C₄alkylamino, di(C₁-C₄alkyl)amino, C₁-C₂₅alkanoyloxy, C₁-C₂₅alkanoylamino, C₃-C₂₅alkenoyloxy, C₃-C₂₅alkanoyloxy interrupted by oxygen, sulfur or by 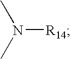
C₆-C₉cycloalkylcarbonyloxy, benzoyloxy or C₁-C₁₂alkyl-substituted benzoyloxy; or the radicals R₂ and R₃ or the radicals R₃ and R₄ or the radicals R₄ and R₅ together with the carbon atoms to which they are bonded form a benzo ring, or R₄ may additionally be —(CH₂)ₚ—COR₁₅ or —(CH₂)_{q}OH, or when R₃, R₅ and R₆ are hydrogen, R₄ may additionally be a radical of formula III 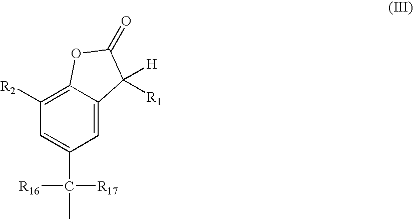
wherein R₁ is as defined above for n=1,
R₆ is hydrogen or a radical of formula IV 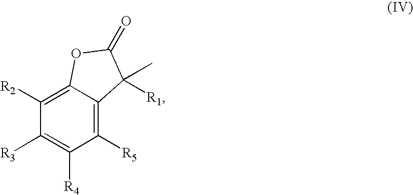
wherein R₄ is not a radical of formula III and R₁ is as defined above for n=1,
R₇, R₈, R₉, R₁₀ and R₁₁ are each independently of the others hydrogen, halogen, hydroxy, C₁-C₂₅alkyl, C₂-C₂₅alkyl interrupted by oxygen, sulfur or by 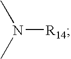
C₁-C₂₅alkoxy, C₂-C₂₅alkoxy interrupted by oxygen, sulfur or by 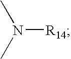
C₁-C₂₅alkylthio, C₃-C₂₅alkenyl, C₃-C₂₅alkenyloxy, C₃-C₂₅alkynyl, C₃-C₂₅alkynyloxy, C₇-C₉phenylalkyl, C₇-C₉phenylalkoxy, unsubstituted or C₁-C₄alkyl-substituted phenyl; unsubstituted or C₁-C₄alkyl-substituted phenoxy; unsubstituted or C₁-C₄alkyl-substituted C₅-C₈cycloalkyl; unsubstituted or C₁-C₄alkyl-substituted C₅-C₈cycloalkoxy; C₁-C₄alkylamino, di(C₁-C₄alkyl)amino, C₁-C₂₅alkanoyl, C₃-C₂₅alkanoyl interrupted by oxygen, sulfur or by 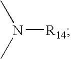
C₁-C₂₅alkanoyloxy, C₃-C₂₅alkanoyloxy interrupted by oxygen, sulfur or by 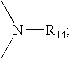
C₁-C₂₅alkanoylamino, C₃-C₂₅alkenoyl, C₃-C₂₅alkenoyl interrupted by oxygen, sulfur or by 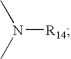
C₃-C₂₅alkenoyloxy, C₃-C₂₅alkenoyloxy interrupted by oxygen, sulfur or by 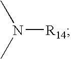
C₆-C₉cycloalkylcarbonyl, C₆-C₉cycloalkylcarbonyloxy, benzoyl or C₁-C₁₂alkyl-substituted benzoyl; benzoyloxy or C₁-C₁₂alkyl-substituted benzoyloxy; 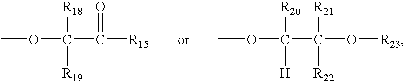
or in formula II the radicals R₇ and R₈ or the radicals R₈ and R₁₁ together with the carbon atoms to which they are bonded form a benzo ring,
R₁₂ and R₁₃ are each independently of the other unsubstituted or C₁-C₄alkyl-substituted phenylene or naphthylene,
R₁₄ is hydrogen or C₁-C₈alkyl,
R₁₅ is hydroxy,
$$[ {—O}^{-} \frac{1}{r} {M}^{r +} ] ,$$
C₁-C₁₈alkoxy or 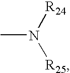
R₁₆ and R₁₇ are each independently of the other hydrogen, CF₃, C₁-C₁₂alkyl or phenyl, or R₁₆ and R₁₇ together with the carbon atom to which they are bonded form a C₅-C₈cycloalkylidene ring that is unsubstituted or substituted by from 1 to 3 C₁-C₄alkyl groups;
R₁₈ and R₁₉ are each independently of the other hydrogen, C₁-C₄alkyl or phenyl,
R₂₀ is hydrogen or C₁-C₄alkyl,
R₂₁ is hydrogen, unsubstituted or C₁-C₄alkyl-substituted phenyl; C₁-C₂₅alkyl, C₂-C₂₅alkyl interrupted by oxygen, sulfur or by 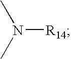
C₇-C₉phenylalkyl that is unsubstituted or substituted on the phenyl radical by from 1 to 3 C₁-C₄alkyl groups; C₇-C₂₅phenylalkyl that is unsubstituted or substituted on the phenyl radical by from 1 to 3 C₁-C₄alkyl groups and interrupted by oxygen, sulfur or by 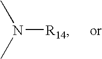
the radicals R₂₀ and R₂₁ together with the carbon atoms to which they are bonded form a C₅-C₁₂cycloalkylene ring that is unsubstituted or substituted by from 1 to 3 C₁-C₄alkyl groups;
R₂₂ is hydrogen or C₁-C₄alkyl,
R₂₃ is hydrogen, C₁-C₂₅alkanoyl, C₃-C₂₅alkenoyl, C₃-C₂₅alkanoyl interrupted by oxygen, sulfur or by 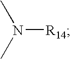
C₂-C₂₅alkanoyl substituted by a di(C₁-C₆alkyl)phosphonate group; C₆-C₉cycloalkylcarbonyl, thenoyl, furoyl, benzoyl or C₁-C₁₂alkyl-substituted benzoyl; 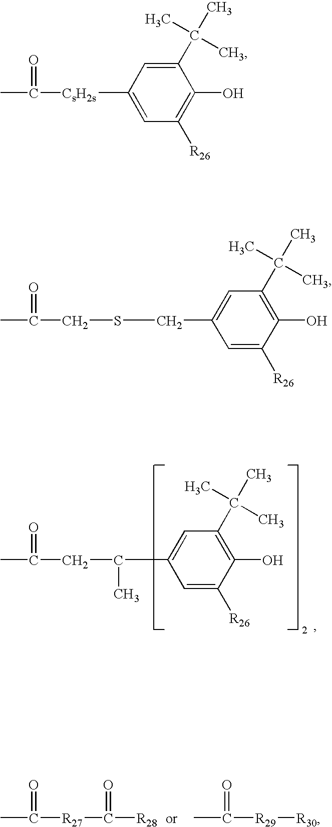
R₂₄ and R₂₅ are each independently of the other hydrogen or C₁-C₁₈alkyl,
R₂₆ is hydrogen or C₁-C₈alkyl,
R₂₇ is a direct bond, C₁-C₁₈alkylene, C₂-C₁₈alkylene interrupted by oxygen, sulfur or by 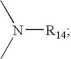
C₂-C₁₈alkenylene, C₂-C₂₀alkylidene, C₇-C₂₀phenylalkylidene, C₅-C₈cycloalkylene, C₇-C₈bicycloalkylene, unsubstituted or C₁-C₄alkyl-substituted phenylene, 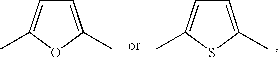
R₂₈ is hydroxy,
$$[ {—O}^{-} \frac{1}{r} {M}^{r +} ] ,$$
C₁-C₁₈alkoxy or 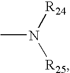
R₂₉ is oxygen, —NH— or 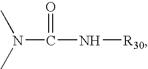
R₃₀ is C₁-C₁₈alkyl or phenyl,
R₃₁ is hydrogen or C₁-C₁₈alkyl,
M is an r-valent metal cation,
X is a direct bond, oxygen, sulfur or —NR₃₁—,
n is 1 or 2,
p is 0,1 or 2,
q is 1, 2, 3, 4, 5 or 6,
r is 1, 2 or 3, and
s is 0, 1 or 2.

18. A method according to claim 17, comprising as component of the benzofuran-2-one type a compound of formula V 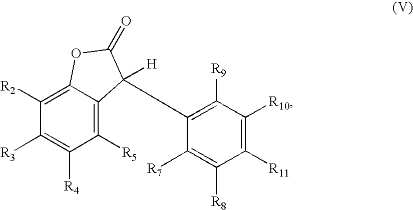
wherein
R₂ is hydrogen or C₁-C₆alkyl,
R₃ is hydrogen,
R₄ is hydrogen or C₁-C₆alkyl,
R₅ is hydrogen,
R₇, R₈, R₉, R₁₀ and R₁₁ are each independently of the others hydrogen, C₁-C₄alkyl, C₁-C₄alkoxy or 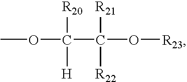
with the proviso that at least two of the radicals R₇, R₃, R₉, R₁₀ and R₁₁ are hydrogen,
R₂₀, R₂₁ and R₂₂ are hydrogen, and
R₂₃ is C₂-C₄alkanoyl.

19. A method according to claim 18, wherein the component of the benzofuran-2-one type is a compound of formula Va or Vb 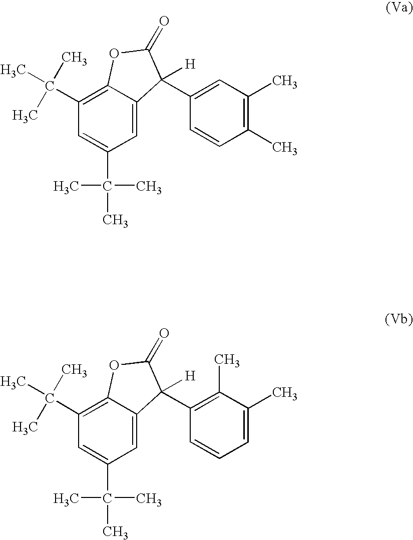
or a mixture of the two compounds of formulae Va and Vb.

20. A method according to claim 12, wherein the sterically hindered nitroxyl free-radical or the compound of the benzofuran-2-one type is present in an amount of from 0.0001 to 10% by weight, based on the total amount of monomer, oligomer, co-oligomer, polymer or copolymer.
